(19) United States
(12) Patent Application Publication
(10) Pub. No.: US 2026/0332603 A1
(43) Pub. Date: Oct. 22, 2026

(54) SYSTEM

(71) Applicant: SoftBank Group Corp., Tokyo (JP)

(72) Inventor: Kenichiro YOKOTA, Tokyo (JP)

(73) Assignee: SoftBank Group Corp., Tokyo (JP)

(21) Appl. No.: 19/650,345

(22) Filed: Apr. 17, 2026

(30) Foreign Application Priority Data
Apr. 21, 2025 (JP) 2025-070018

(51) Int. Cl. H04L 9/40; G06V 10/74; G06V 10/82; G06V 40/16

(52) U.S. Cl. CPC H04L 63/108; G06V 10/761; G06V 10/82; G06V 40/171; H04L 63/0861

(57) ABSTRACT

The present invention relates to a system that automatically and optimally executes account creation, deletion, authority change, and the like for a plurality of business systems in conjunction with personnel events such as joining, leaving, and transferring of all employees including outsourced contract employees in the telecommunications industry, IT-related companies, and the like. The system comprises a personnel information management unit, an event detection unit, an automatic account authority management unit, a generative AI execution unit, and the like, wherein generative AI analyzes business content, a past authority history, a security policy, a system usage status, and the like of an employee, and realizes an optimal account management procedure, exception processing, and automatic recording of an audit trail while preventing a deletion omission and an authority grant mistake. Thereby, a reduction in security risks, an improvement in operational efficiency, and a strengthening of governance can be simultaneously achieved.

### CROSS-REFERENCE TO RELATED APPLICATION

The present application claims priority to and incorporates by reference the entire contents of Japanese Patent Application No. 2025-070018 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to comprehensively and efficiently solve a wide variety of problems such as that, in an environment where a large number of employees including outsourced contract employees are enrolled and personnel events such as joining, leaving, and transferring frequently occur in the telecommunications industry, IT-related companies, and the like, management work such as new issuance, deletion, and authority change of accounts in various business systems is complicated and relies on manual work, so that account deletion omissions and erroneous authority grants for leavers and transferees are likely to occur, and serious security risks such as information leakage and unauthorized access caused by this are always inherent; furthermore, an operational load and cost of account management increase due to an increase in the types and number of business systems to be managed, making human errors and response delays more likely to occur; moreover, it is difficult to perform optimal authority setting and exception processing according to changes in business content of employees and an organizational structure; and in addition, visualization and automation of an audit trail of account management and a security policy compliance status have not been sufficiently realized. In order to solve these problems, an object of the present invention is to simultaneously achieve a reduction in security risks, an improvement in operational efficiency, a reduction in management costs, and a strengthening of governance by linking a personnel system and various business systems and providing a mechanism for centrally and autonomously realizing automatic management, optimization, auditing, and exception processing of accounts and authorities using generative AI.

### SUMMARY OF THE INVENTION

A means for solving the problem according to the present invention is to configure a system comprising a personnel information management unit, an event detection unit, an automatic account authority management unit, and a generative AI execution unit, wherein first, the personnel information management unit centrally manages personnel event information such as joining, leaving, and transferring of all employees including outsourced contract employees; the event detection unit monitors the personnel events recorded in the personnel information management unit in real time or at a predetermined cycle to immediately detect an occurrence of an event; the automatic account authority management unit automatically executes processing such as new creation, deletion, and authority change of an account of a corresponding employee for a plurality of business systems based on the event detected by the event detection unit; and the generative AI execution unit uses generative AI to analyze various information such as a role, business content, an affiliated department, a past authority history, and a security policy of the employee in the processing of the automatic account authority management unit, and to autonomously determine and execute optimal account authority setting, a deletion procedure, exception processing, audit log generation, and the like, thereby preventing account deletion omissions and erroneous authority grants for leavers and transferees, reducing security risks such as information leakage and unauthorized access, and simultaneously realizing an improvement in efficiency of account management work, a reduction in operational load, and a strengthening of governance.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

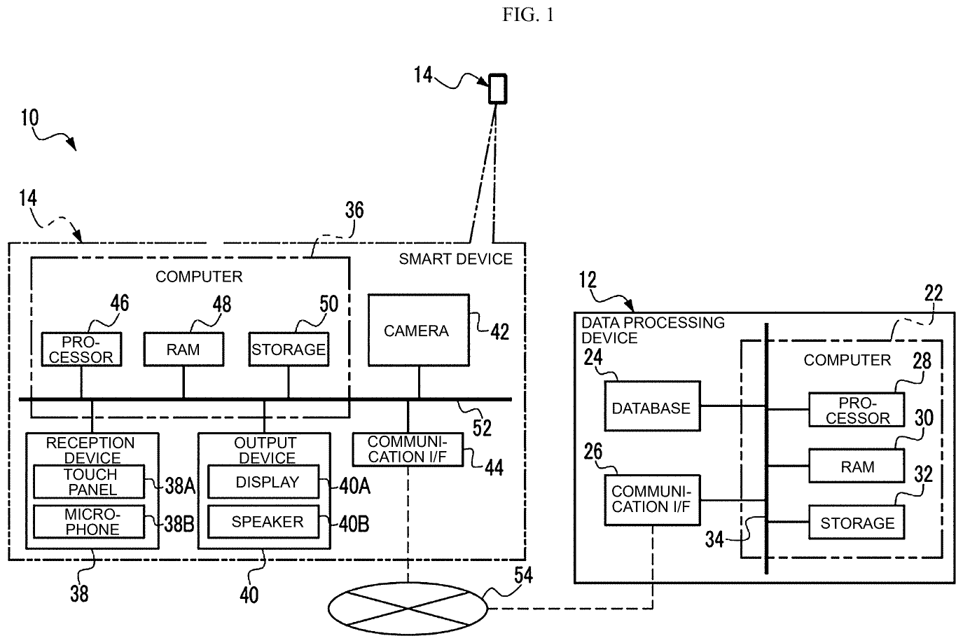

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

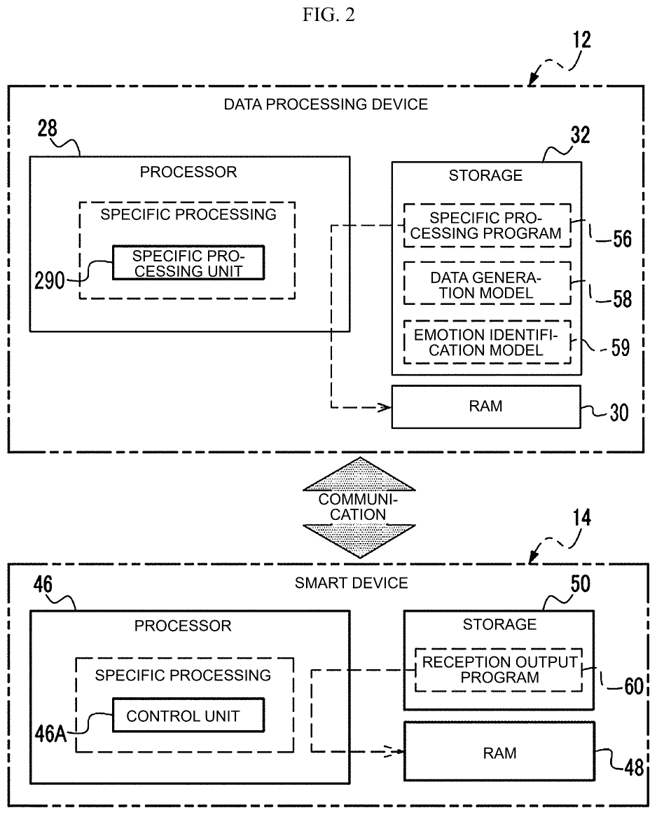

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described exhaustively, in detail, and specifically, assuming a configuration using a server and a terminal, covering specific operations of each unit, a utilization method of generative AI, a flow of the entire system, an actual operation example, exception processing, a security measure, an operation example of an administrator or a user, handling of various logs and an audit trail, system expandability, integration with other systems, response at the time of failure, and education/operation support.

First, a personnel information management unit operates on a server, and centrally manages all personnel-related data as a database, such as attribute information, an employment form, a joining date, a leaving date, a transferring history, an affiliated department, a project in charge, a job title, contact information, emergency contact information, a past personnel evaluation, qualification information, an education history, a past authority history of an account, and a system usage history of all employees such as an outsourced contract employee, a regular employee, a dispatched employee, and a part-time worker. For example, when an employee A joins on Apr. 1, 2024, transfers from a sales department to an information system department on Jun. 1, 2024, and leaves on Dec. 31, 2024, all of these events are recorded in chronological order, and a related business system and authority information are also linked and held for each event. On a terminal side, a person in charge of personnel can perform browsing, correction, event registration, history confirmation, CSV import/export, API integration setting, and the like of employee information using a Web browser or a dedicated application. Specifically, the personnel information management unit constructs a relational database management system on a main storage device and an auxiliary storage device of the server. The personnel information management unit normalizes the attribute information of the employee, and divides and stores the attribute information into a plurality of data tables. The personnel information management unit assigns a unique identifier to each employee. The personnel information management unit joins the respective tables using this identifier as a primary key. The personnel information management unit records a personnel event occurring in chronological order as transaction data. The personnel information management unit assigns a time stamp to each event record. The personnel information management unit automatically generates a B-tree index for a frequently searched column such as an affiliated department or a job title in order to improve a search speed. The personnel information management unit receives a data acquisition request from the terminal. The personnel information management unit converts the received request into an SQL query. The personnel information management unit executes the query using a database engine. The personnel information management unit serializes the extracted data into a JSON format payload. The personnel information management unit transmits the data to the terminal via an encrypted communication path. The personnel information management unit executes a validation process for detecting a data type mismatch or a missing essential item when importing a CSV file. The personnel information management unit skips processing of a corresponding row and generates an error log when detecting an error. As a technical effect, the personnel information management unit eliminates data redundancy and reduces a storage capacity. The personnel information management unit shortens a search latency for millions of records to a millisecond unit by utilizing the index. As a specific application field, the system is used as a global personnel information integration platform in a multinational corporation having tens of thousands of employees.

An event detection unit operates on the server, and monitors the database of the personnel information management unit in real time. For example, an employee whose scheduled joining date is today is automatically extracted and detected as a joining event. An employee whose leaving date has arrived is automatically detected and processed as a leaving event. When a transferring date has arrived, it is detected as a transferring event. These detections can correspond to any of regular batch processing (for example, every 5 minutes, every 1 hour, once a day, etc.), real-time event notification by an API, or manual registration by a person in charge of personnel. On the terminal side, an interface is provided that automatically transmits an email notification, a chat notification, a push notification, or the like to an administrator or a related person upon occurrence of an event, and prompts confirmation or approval of event content, input of additional information, or the like. Specifically, the event detection unit executes a regular polling process on the database of the personnel information management unit. The event detection unit compares a previous polling execution time with a current system time. The event detection unit extracts a time stamp of a record updated within this time frame. The event detection unit analyzes difference data of the extracted record. The event detection unit detects a flag indicating a specific state transition such as joining or leaving. When detecting the state transition, the event detection unit generates an event message including a code indicating a corresponding event type and an employee identifier. The event detection unit publishes the generated event message to a queue of an asynchronous messaging broker. The event detection unit exposes a Webhook endpoint on the server for receiving a real-time notification via an API. The event detection unit receives an HTTP POST request from an external system. The event detection unit parses JSON data in a request body. The event detection unit extracts event information from the parsed data. In a notification process, the event detection unit acquires contact information of an administrator serving as a destination from the database. The event detection unit transmits notification data to a mail server using an SMTP protocol. As a technical effect, the event detection unit distributes a continuous query load on the database and reduces a CPU usage rate of the server. The event detection unit prevents an omission of an event and improves a throughput of the entire system by adopting asynchronous messaging. As a specific application field, the system is used as a real-time authority switching system in a temporary staffing industry where daily joining, leaving, and transferring are intense.

An automatic account authority management unit operates on the server, and automatically executes processing such as new creation, deletion, authority change, password initialization, account lock, access restriction, two-factor authentication setting, usage period setting, account activation/deactivation, group addition/deletion, role assignment, and API key issuance/revocation of an account of a corresponding employee for a plurality of business systems (for example, a mail system, a file sharing system, groupware, a project management system, a cloud platform, a customer management system, an expense settlement system, an attendance management system, a remote access system, a VPN, a network device, a physical entry/exit management system, etc.) based on the event information notified from the event detection unit. For example, at the time of a joining event, an account of a necessary business system is automatically newly created, an initial password is issued, and the account is automatically added to a necessary authority or group according to an affiliated department, a job title, or a project in charge of the employee. At the time of a leaving event, the account of the corresponding employee is automatically deleted from all the business systems, the account is deactivated for a system that cannot be deleted, an access authority is deprived, an API key or a token is revoked, and a physical entry/exit authority is also immediately stopped. At the time of a transferring event, an authority of an old department is automatically deleted, a necessary authority is automatically granted to a new department, and authority transfer in units of projects is also automatically performed. For example, when an employee B transfers from the sales department to a development department, an access authority of a sales system is deleted, and an administrator authority of a development system is newly granted. Furthermore, an authority consistency check is also automatically executed so that duplication or contradiction of authorities among the plurality of business systems does not occur. Specifically, the automatic account authority management unit subscribes to the event message from the asynchronous messaging broker. The automatic account authority management unit acquires detailed attribute information from the personnel information management unit using the employee identifier included in the event message as a key. The automatic account authority management unit collates the acquired attribute information with a predefined policy rule of role-based access control. The automatic account authority management unit specifies a target business system group. The automatic account authority management unit generates an HTTP request for an endpoint of a RESTful API provided by each business system. The automatic account authority management unit adds an access token based on an OAuth authentication protocol to a request header. The automatic account authority management unit stores a parameter for account creation or authority change in a JSON format in a request body. The automatic account authority management unit transmits the request via a network interface. The automatic account authority management unit receives an HTTP status code from the business system. When the status code indicates success, the automatic account authority management unit records a log of processing completion. In the authority consistency check, the automatic account authority management unit acquires a current authority state from each business system. The automatic account authority management unit calculates a difference set between a set of the acquired authority states and a set of ideal authority states based on the policy rule. When the difference set is not empty, the automatic account authority management unit detects an inconsistency. The automatic account authority management unit automatically issues an additional API request for resolving the inconsistency. As a technical effect, the automatic account authority management unit completely eliminates manual setting work by a human, and mathematically brings an occurrence probability of a security incident due to a setting mistake close to zero. The automatic account authority management unit transmits requests to the plurality of business systems simultaneously using parallel processing threads, and significantly shortens an overall processing time. As a specific application field, the system is used as an automatic lifecycle management system for a privileged ID in a financial institution where strict access control is required.

A generative AI execution unit operates on the server, and uses generative AI to analyze, determine, and optimize various information in the processing of the automatic account authority management unit. For example, the generative AI comprehensively analyzes a role, business content, an affiliated department, a past authority history, a system usage history of the employee, an authority hierarchical structure in an organization, a security policy, case data of past deletion omissions and authority grant mistakes, an audit trail, external threat information, a legal compliance requirement, and the like. For example, at the time of account deletion of a retiree, a past deletion omission pattern or a dependency relationship between systems is learned, a system having a high deletion omission risk is automatically specified, and deletion processing is intensively performed. For example, at the time of transferring, the business content of the employee or an authority requirement of a new or old department is analyzed, and an optimal authority grant/deletion procedure is automatically generated. For example, when the employee performs business across a plurality of projects, the generative AI analyzes a system usage status or an authority history for each project, and optimizes account deletion or authority deprivation necessary at the time of leaving in units of projects. For example, when the employee is temporarily granted an administrator authority, the authority is automatically deprived so that an unnecessary administrator authority does not remain after transferring. For example, when the employee uses a plurality of cloud platforms or external services, the generative AI collectively executes account deletion or authority change for all the external services through API integration, and prevents a deletion omission or an authority grant mistake. For example, when leaving of the employee is suddenly determined, the generative AI can immediately lock accounts of all systems and automatically transmit an alert prompting the administrator for an emergency response. For example, when the employee performs business across a plurality of contract forms or a plurality of employers, the generative AI analyzes contract content or an authority requirement for each employer, and automatically generates an optimal account management procedure for each contract. Specifically, the generative AI execution unit deploys a large language model based on a transformer architecture provided with a self-attention mechanism on a GPU cluster of the server. The generative AI execution unit converts structured data such as personnel information, an authority history, and a system usage history into a natural language text prompt. The generative AI execution unit converts this text prompt into an integer token ID array using a tokenizer. The generative AI execution unit maps the token ID array to a multidimensional embedding vector space. The generative AI execution unit inputs this embedding vector as an input tensor to the large language model. As a specific example of input data, first, there is a 512-dimensional feature vector obtained by digitizing an affiliated department, a job title, and a past system login frequency of the employee. Second, there is a token array in which an authority change history for the past one year is arranged in chronological order. Third, there is adjacency matrix data indicating a dependency relationship among the respective business systems. The generative AI execution unit calculates a relevance among respective elements of the input tensor using a plurality of attention heads inside the large language model. The generative AI execution unit executes a forward propagation operation, and outputs an appearance probability distribution of each token from an output layer. The generative AI execution unit generates text data indicating an optimal account management procedure based on the probability distribution. As a specific example of output data, first, there is a floating-point number score from 0.0 to 1.0 indicating a deletion recommendation degree for each business system. Second, there is a character string label indicating a role name of an authority to be granted. Third, there is JSON format data in which an order and a parameter of an API call to be executed are structured. The generative AI execution unit inputs the output JSON data to a parser module. The parser module extracts a specific command group from the JSON data. The parser module transmits the extracted command group to the automatic account authority management unit, and triggers an actual API call. The generative AI execution unit uses past deletion omission case data as teacher data, and fine-tunes a weight parameter of a model by backpropagation so as to minimize a cross-entropy error function. As a technical effect, the generative AI execution unit analyzes a complex system dependency relationship or an exceptional employment form, which is difficult to describe on a conventional rule basis, on a multidimensional space, and derives an optimal authority management procedure that cannot be discovered by a human. The generative AI execution unit predicts a risk with high accuracy even for an unknown authority grant pattern by a high-dimensional vector operation. As a specific application field, the system is used as an automatic detection and authority optimization system for shadow IT in an IT company that uses a combination of a plurality of cloud services.

Furthermore, the generative AI is also utilized for automatic recording and visualization of an audit trail of account management and a security policy compliance status. For example, a creation, deletion, and authority change history of each account is automatically recorded, and a report for an audit response or internal control is automatically generated. For example, when an authority setting violating the security policy is detected, the generative AI can automatically present a corrective plan and notify the administrator. For example, at the time of an audit response, a past account management history is visualized in chronological order, and a dashboard capable of confirming at a glance who granted or deleted what kind of authority and when is automatically generated. For example, when a legal compliance requirement is changed, the generative AI can automatically propose an authority setting based on a new requirement, and automatically apply the authority setting through approval of the administrator. Specifically, the generative AI execution unit collects a huge amount of system log data output from an audit recording unit. The generative AI execution unit extracts a feature amount such as an operation date and time, an operator ID, a target system, and operation content from the collected log data. The generative AI execution unit normalizes the extracted feature amount, and converts the feature amount into time-series numerical array data. The generative AI execution unit inputs this numerical array data as an input tensor to a neural network model specialized for anomaly detection. As a specific example of input data, first, there is a one-dimensional array obtained by normalizing the number of API calls of each user for the past 30 days. Second, there is data obtained by vectorizing geographical information of an IP address where an operation was performed. The generative AI execution unit calculates an anomaly score for each log entry as an output of the model. As a specific example of output data, first, there is an anomaly score of an integer value from 0 to 100 indicating a degree of deviation from a normal operation pattern. Second, there is text data explaining a reason determined to be an anomaly in a natural language. Third, there is a character string of a specific system command to be executed for correction. When the anomaly score exceeds a preset threshold value, the generative AI execution unit activates an alert generation module as subsequent processing. The alert generation module generates a notification message including details of the anomaly and corrective plan text, and transmits the notification message to a terminal of the administrator. The generative AI execution unit periodically crawls and acquires external text data indicating a change in a legal compliance requirement. The generative AI execution unit extracts a new constraint condition from the text data using a natural language processing technology. The generative AI execution unit maps the extracted constraint condition to a parameter of an existing security policy, and automatically generates an updated policy file. As a technical effect, the generative AI execution unit instantaneously specifies a minute anomaly pattern that cannot be discovered by human visual inspection from millions of lines of log data, and realizes early discovery of a security incident. The generative AI execution unit automates policy update work accompanying a legal change, and reduces a risk of a compliance violation. As a specific application field, the system is used as an automatic audit and compliance maintenance system in a medical institution or a public institution that needs to strictly comply with a personal information protection law or various industry regulations.

On the terminal side, a dashboard is provided that allows an administrator or a person in charge of personnel to confirm an account management status for each employee, a risk evaluation result by the generative AI, an alert notification, an audit trail, and the like in real time through a Web browser or a dedicated application. For example, the administrator can also perform an account lock in an emergency or an exceptional authority grant application from the terminal. For example, a transferring or leaving event of an employee can be manually registered from the terminal, and account management processing can be immediately triggered. For example, an audit report can be downloaded from the terminal and submitted to an external auditor or a management layer. Specifically, the terminal receives HTML, Cascading Style Sheets, and JavaScript files transmitted from the server. The terminal analyzes these files using a rendering engine of a browser, and constructs a tree of a document object model on a memory. The terminal generates a virtual document object model using a front-end framework. The terminal establishes an always-connected communication session using a WebSocket protocol with the server. The terminal receives update data in a JSON format transmitted in real time from the server. The terminal updates the virtual document object model based on the received data. The terminal calculates a difference between the virtual models before and after the update. The terminal applies only the difference to an actual document object model, and updates drawing of a screen at high speed. The terminal detects a mouse click or a keyboard input from the administrator with an event listener. When an account lock request in an emergency is input, the terminal generates a payload including a target account identifier and a lock instruction. The terminal transmits the payload to the server as an HTTPS request encrypted by a Transport Layer Security protocol. The terminal receives binary data of an audit report in a PDF format or a CSV format from the server. The terminal saves the received binary data as a file in a local storage device. As a technical effect, the terminal minimizes a CPU load and memory consumption required for redrawing the screen by a difference drawing algorithm, and shortens a response delay to a user operation to a millisecond unit. The terminal prevents data eavesdropping or falsification via a network by encrypted communication. As a specific application field, the system is used as a console for a system administrator of a large-scale call center where a large number of administrators access simultaneously and an instantaneous determination and operation are required.

As for system expandability, a structure is adopted that can easily respond by API integration or plugin addition even when a new business system or external service is added. For example, even for a newly introduced cloud service, the generative AI can automatically analyze an API specification and automatically generate an account management flow. For example, integration with an overseas base or a group company is also supported, and multilingual support, time zone support, local legal regulation support, and the like are also automatically optimized. Specifically, the system containerizes each function as an independent microservice. The system operates these containers on a container orchestration platform. When a new business system is added, the system automatically registers a URL of a new endpoint in a registry using a dynamic API discovery function. The system reads a JSON or YAML file in an OpenAPI format, which is an API specification document of a new system, using the generative AI execution unit. The generative AI execution unit analyzes a path, a method, and a schema of a request body in the specification document. The generative AI execution unit automatically generates an adapter code defining a data mapping rule and a communication protocol for communicating with the new system based on an analysis result. The system dynamically compiles the automatically generated adapter code, and loads the adapter code into an execution environment. In integration with an overseas base, the system acquires a system time zone setting of a server of each base. The system executes an offset calculation of a time stamp based on Coordinated Universal Time, and accurately synchronizes an occurrence order of events. The system extracts locale information of a user from an HTTP request header. The system loads a language resource file corresponding to the locale information into a memory, and dynamically switches a display language of an interface. As a technical effect, the system adds an integration function with a new external service without stopping without accompanying system modification or restart, and enhances availability of the system to the utmost limit. The system eliminates a contradiction in an order property of a distributed transaction in a global environment by automatic correction of a time zone. As a specific application field, the system is used as an integrated ID management platform in a global conglomerate company that frequently acquires companies and needs to rapidly integrate a wide variety of IT systems.

As for response at the time of failure, when account deletion or authority change processing fails, the generative AI automatically proposes retry processing or an alternative procedure, and notifies the administrator. For example, when a business system of an API integration destination is down, reprocessing is automatically executed after recovery. For example, when an account to be deleted does not already exist, that fact is automatically recorded in an audit trail, and reported to the administrator. Specifically, the system activates a timer for measuring a response time when transmitting an API request to an external system. The system determines that a communication failure has occurred when there is no response within a preset timeout time or when an HTTP status code in the 500s is received. When detecting a failure, the system transitions a state of a circuit breaker module to open, and temporarily blocks subsequent useless request transmission. The system executes an exponential backoff algorithm. The system registers a request in a retransmission queue while exponentially increasing a retry interval. The system analyzes an error message or a stack trace of a failure using the generative AI execution unit. The generative AI execution unit classifies whether a cause of an error is a temporary disconnection of a network, expiration of authentication information, or absence of a target account. When receiving a 404 error indicating that the target account does not already exist, the system cancels retry processing. The system inserts a log record including a status code indicating a processing skip due to account absence and a time stamp into a database of an audit recording unit. The system assigns a unique trace ID to a request using a distributed tracing technology. The system records a processing path across a plurality of microservices and a processing time at each point, and specifies a bottleneck. As a technical effect, the system prevents a cascading failure caused by a failure of an external system, and avoids resource exhaustion of the entire system. The system prevents concentration of traffic on an external system immediately after recovery by exponential retry control, and realizes stable reconnection. As a specific application field, the system is used as a highly fault-tolerant authority synchronization system in a manufacturing industry that integrates with systems of a plurality of overseas factories under an unstable network environment.

As for education/operation support, the generative AI provides a best practice of account management, a past operation example, an explanation of a security risk, an automatic guide of an operation procedure, automatic FAQ generation, and the like for an administrator or a person in charge of personnel. For example, a newly appointed administrator is enabled to browse an operation manual or a tutorial video from the terminal. For example, a case of a deletion omission or an authority grant mistake that occurred in the past is automatically extracted, and utilized as an alert or an educational material. Specifically, the system constructs a retrieval-augmented generation architecture on the server. The system divides a text document such as a past operation manual, a security guideline, or a failure response history into chunk units. The system converts each chunk into high-dimensional vector data using an embedding model. The system indexes and stores these vector data in a vector database. The system receives question text of the administrator from the terminal. The system similarly vectorizes the question text, and generates a query vector. The system calculates a cosine similarity between the query vector and each document vector on the vector database. The system extracts a higher-level document chunk having a high similarity. The system combines the extracted chunk as a context into a prompt, and inputs the prompt to the generative AI execution unit. As a specific example of input data, first, there is a query vector of a user saying “Please tell me an authority grant procedure for a new employee”. Second, there is text data of a related manual extracted from the vector database. The generative AI execution unit generates accurate answer text to a question based on the context. As a specific example of output data, first, there is text describing a specific operation procedure step by step. Second, there is a URL link of a manual to be referred to. The system displays the generated answer text in a chat format on a screen of the terminal. The system extracts a record including an error code indicating an authority grant mistake from a past audit log. The system analyzes an operation pattern of the extracted record, and dynamically renders a warning pop-up on the screen for an administrator who attempts to perform a similar operation. As a technical effect, the system provides an intuitive interface by a natural language, and significantly reduces a learning cost and time required for system mastery of the administrator. The system generates a highly accurate answer along a context that cannot be reached by a mere keyword search in a millisecond unit by a combination of a vector search and generative AI. As a specific application field, the system is used as a self-resolution type help desk system in an outsourcing center where persons in charge having diverse IT literacy are frequently replaced.

As described above, the embodiment of the present invention comprehensively realizes centralized management of personnel information, event detection, automatic management of account authority, and optimization, exception processing, and audit recording by generative AI on a server, and provides an interface for an administrator or a person in charge of personnel to grasp a system status and perform a necessary operation or approval on a terminal side, thereby highly accurately and efficiently automating account management of all employees including outsourced contract employees, and simultaneously realizing reduction of a security risk, reduction of an operation load, strengthening of governance, improvement of audit response capability, reduction of an operation cost, securing of system expandability, and education and operation support. Specifically, the present system arranges an in-memory database on a main memory of the server, and uses it as a cache for frequently accessed personnel information and authority policies. The present system eliminates a bottleneck of disk IO, and minimizes end-to-end latency from event detection to completion of automatic change of account authority. The present system adopts an event loop architecture combining multi-thread processing and asynchronous IO. The present system suppresses overhead due to a context switch of a thread even for tens of thousands of simultaneously occurring events, and maintains high throughput. The present system applies a model quantization technology in inference processing of the generative AI. The present system halves VRAM consumption of a GPU by reducing precision of floating-point arithmetic to 16 bits or 8 bits. The present system maintains determination accuracy of authority optimization while improving an inference speed. The present system adopts a binary serialization format for communication between respective modules. The present system reduces consumption of a network bandwidth and saves CPU cycles of parse processing compared to a JSON format. As a technical effect, the present system maximizes utilization efficiency of hardware resources, and makes it possible to process transactions several times as many as conventional ones with the same server specifications. The present system physically eliminates a security vulnerability caused by a human error while reducing a human cost required for operation by a synergistic effect of automation and optimization by AI. As a specific application field, the present system is used as a mission-critical integrated authentication and authorization infrastructure in a giant IT platformer having tens of thousands of employees and thousands of business systems and generating thousands of authority change requests per second.

### System Configuration

The system according to the present embodiment includes a personnel information management unit, an event detection unit, an automatic account authority management unit, a generative AI execution unit, a user interface unit, an audit recording unit, and an external system integration unit. The personnel information management unit is a unit configured to centrally manage information regarding employees of various employment forms such as outsourced contract employees, regular employees, dispatched employees, and part-time workers, and holds, for example, an employee's name, employee number, joining date, leaving date, transferring history, affiliated department, project in charge, job title, contact information, emergency contact information, qualification information, education history, past personnel evaluation, past authority history of an account, system usage history, and the like as a database, and can record a plurality of events in chronological order, such as a case where an employee A joins on Apr. 1, 2024, transfers from a sales department to an information system department on Jun. 1, 2024, and leaves on Dec. 31, 2024, and can also manage a related business system and authority information in association with each event. In addition, a person in charge of personnel can also perform browsing, correction, event registration, history confirmation, CSV import/export, API integration setting, and the like of employee information using a Web browser or a dedicated application. Specifically, the present system implements the personnel information management unit as a graph database on the server. The personnel information management unit defines each entity such as an employee, a department, a project, and a job title as a node. The personnel information management unit defines a relationship such as affiliation, charge, and management as an edge. The personnel information management unit assigns a property such as a joining date and a leaving date to each node and edge in a key-value format. The personnel information management unit generates an “affiliation” edge starting from Apr. 1, 2024 between a node of the employee A and a node of the sales department. The personnel information management unit sets an end point of this edge on Jun. 1, 2024 to invalidate it. The personnel information management unit simultaneously generates a new “affiliation” edge with a node of the information system department. The personnel information management unit uses a graph search algorithm to traverse nodes of related projects and colleagues within a certain number of hops from a specific employee at high speed. The personnel information management unit receives a CSV import request from the terminal. The personnel information management unit reads a file stream into a memory buffer. The personnel information management unit parses data of each row in parallel using multi-threading. The personnel information management unit converts the parsed data into a query language of the graph database, and collectively commits it as batch processing. As a technical effect, the personnel information management unit executes data search of a hierarchical structure or a network structure, which requires a complex JOIN operation in a relational database, only by tracking a pointer, and shortens a query execution time to a logarithmic order. The personnel information management unit instantaneously reconstructs an organizational structure at an arbitrary point in time in the past by managing chronological events as properties of edges. As a specific application field, the present system is used as a next-generation personnel data infrastructure in an advanced technology company where affiliation relationships of employees are complex and dynamically change, such as a matrix organization and an agile development team.

The event detection unit is a unit configured to monitor the database of the personnel information management unit in real time or at a predetermined cycle, and immediately detect an event when the event such as joining, leaving, or transferring occurs. For example, an employee whose scheduled joining date is today can be automatically extracted and detected as a joining event, an employee whose leaving date has arrived can be automatically detected and processed as a leaving event, or when a transferring date has arrived, it can be detected as a transferring event. These detections correspond to any of regular batch processing, real-time event notification by API, or manual registration by a person in charge of personnel, and when an event occurs, an alert notification such as an email notification, a chat notification, or a push notification is automatically sent to an administrator or a related person, and an interface for prompting confirmation or approval of event content, input of additional information, and the like is also provided. For example, even when a leaving date of an employee B is suddenly changed, an event can be immediately detected, and account deletion processing can be triggered for all systems. Specifically, the event detection unit deploys a stream processing engine on the server. The event detection unit reads a transaction log of the database of the personnel information management unit in real time using a change data capture technology. The event detection unit inputs the read log stream to a window function on a memory. The event detection unit aggregates event data for each designated time frame, and executes stateful processing for holding a state. The event detection unit detects an UPDATE instruction of changing the leaving date of the employee B from the log stream. The event detection unit compares the leaving date before the change and the leaving date after the change. The event detection unit generates an immediate-firing trigger event when the leaving date after the change is in the past from the current time or coincides with the current time. The event detection unit pushes the generated trigger event to an in-memory message queue. The event detection unit acquires a device token of a terminal of a target administrator from the database in order to send a push notification. The event detection unit asynchronously sends an HTTP request including the device token and a message payload to an API of an external push notification service. As a technical effect, the event detection unit completely eliminates a load due to regular polling to the database, and shortens a delay from occurrence of an event to detection to an order of less than a millisecond. The event detection unit calculates an accurate state transition even for event logs arriving out of order by stateful stream processing, and prevents erroneous detection. As a specific application field, the present system is used as an emergency account suspension mechanism in a trading system of a securities company where deprivation of access authority in units of seconds is required.

The automatic account authority management unit is a unit configured to automatically execute processing such as new creation, deletion, authority change, password initialization, account lock, access restriction, two-factor authentication setting, usage period setting, account activation/deactivation, group addition/deletion, role assignment, and API key issuance/revocation of an account of a corresponding employee for a plurality of business systems based on the event information notified from the event detection unit. For example, at the time of a joining event, an account of a necessary business system is automatically newly created according to an affiliated department, a job title, and a project in charge of an employee, an initial password is issued, and the employee is automatically added to a necessary authority or group. At the time of a leaving event, an account of a corresponding employee is automatically deleted from all business systems, and for a system that cannot be deleted, the account is deactivated, access authority is deprived, an API key or a token is revoked, and physical entry/exit authority is also immediately suspended. At the time of a transferring event, authority of an old department is automatically deleted, necessary authority for a new department is automatically granted, and authority transfer in units of projects is also automatically performed. For example, when an employee C transfers from a sales department to a development department, access authority of a sales system is deleted, and administrator authority of a development system is newly granted. Furthermore, an authority consistency check is also automatically executed so that duplication or contradiction of authority among a plurality of business systems does not occur. Specifically, the automatic account authority management unit constructs a state machine for controlling a distributed transaction on the server. Upon receiving the event information, the automatic account authority management unit generates a directed acyclic graph defining a series of API call tasks for each target business system. The automatic account authority management unit executes the tasks sequentially or in parallel according to dependency relationships of the graph. The automatic account authority management unit assigns a unique transaction ID to a request header in each API call. The automatic account authority management unit ensures idempotency on the business system side, and prevents double processing due to a network retry. The automatic account authority management unit executes an authority deletion task of the sales system and an authority grant task of the development system in parallel threads in the transferring event of the employee C. When any of the tasks fails, the automatic account authority management unit automatically issues a compensating transaction based on a saga pattern. The automatic account authority management unit rolls back processing of a successful task, and maintains consistency of the entire system. In the authority consistency check, the automatic account authority management unit calculates a hash value of an authority list acquired from each system. The automatic account authority management unit compares the calculated hash value with a hash value of an authority list serving as a correct answer. The automatic account authority management unit executes detailed difference comparison processing only when the hash values do not match. As a technical effect, the automatic account authority management unit minimizes an execution time of authority change processing having a complex dependency relationship by task scheduling based on a directed acyclic graph. The automatic account authority management unit significantly reduces CPU cycles required for a comparison operation by a consistency check using a hash value, and completes a check of tens of thousands of accounts in a few seconds. As a specific application field, the present system is used as a dynamic provisioning system of access authority of a developer in a large-scale EC site composed of hundreds of independent microservice groups.

The generative AI execution unit is a unit configured to use generative AI to analyze, determine, and optimize various information in the processing of the automatic account authority management unit. For example, it comprehensively analyzes a role, business content, an affiliated department, a past authority history, a system usage history of an employee, an authority hierarchical structure in an organization, a security policy, case data of past deletion omissions and authority grant mistakes, an audit trail, external threat information, a legal compliance requirement, and the like. When deleting an account of a retiree, it learns past deletion omission patterns and dependency relationships between systems, automatically identifies a system having a high deletion omission risk, and intensively performs deletion processing. At the time of transferring, it analyzes business content of an employee and authority requirements of old and new departments, and automatically generates an optimal authority grant/deletion procedure. When an employee performs business across a plurality of projects, the generative AI analyzes a system usage status and an authority history for each project, and optimizes account deletion and authority deprivation necessary at the time of leaving in units of projects. When an employee is temporarily granted administrator authority, the authority is automatically deprived so that unnecessary administrator authority does not remain after transferring. When an employee uses a plurality of cloud infrastructures or external services, the generative AI collectively executes account deletion and authority change for all external services through API integration, and prevents a deletion omission and an authority grant mistake. When leaving of an employee is suddenly decided, the generative AI can immediately lock accounts of all systems, and automatically send an alert notification prompting an administrator to take an emergency response. Specific examples of a prompt sentence to be read by the generative AI include “A leaving event of an employee X has occurred. Identify accounts of all business systems used by X in the past, preferentially delete a system having a high deletion omission risk, and record a deletion result in an audit recording unit”, “An employee Y has transferred from a sales department to a development department. Analyze business content of Y and authority requirements of old and new departments, delete unnecessary authority, and generate an optimal procedure for granting necessary authority”, “An employee Z was performing business across a plurality of projects. Analyze a system usage status for each project of Z, and optimize account deletion and authority deprivation necessary at the time of leaving in units of projects”, and “Learn case data of past deletion omissions and authority grant mistakes, and automatically optimize a future account management procedure”. Specifically, the generative AI execution unit controls a large language model using a few-shot prompting method. The generative AI execution unit arranges several examples of input/output pairs of past successful authority changes at the beginning of an input prompt. The generative AI execution unit subsequently adds current event information as a context. The generative AI execution unit tokenizes this prompt character string, and inputs it to a context window of the model. As specific examples of input data, first, there is a token array of a natural language “A leaving event of an employee X has occurred. Identify accounts of all business systems used by X in the past, preferentially delete a system having a high deletion omission risk, and record a deletion result in an audit recording unit”. Second, there is a vector representation of a past system access log of the employee X. Third, there is a numerical matrix indicating a deletion difficulty level of each system. The generative AI execution unit autoregressively predicts a next token in a decoder layer of the model, and generates an output sequence. As specific examples of output data, first, there is a JSON array including an ID list of systems to be preferentially deleted. Second, there is a character string of a deletion command for each system. Third, there is a text of a log message to be sent to the audit recording unit. The generative AI execution unit passes the output JSON array to a subsequent command execution module. The command execution module parses the JSON array, and generates and sends API requests in a designated order. The generative AI execution unit determines that a risk of hallucination is high when an output probability of the model falls below a certain threshold. The generative AI execution unit pauses automatic execution, and branches processing to a workflow requesting approval from an administrator. As a technical effect, the generative AI execution unit exhibits high inference accuracy for an unknown system configuration or a complex transferring pattern without performing re-learning of the model by few-shot prompting. The generative AI execution unit prevents a fatal system failure due to an erroneous determination of AI by branch processing based on a certainty factor of an output. As a specific application field, the present system is used as an intelligent authority transition system in a central government ministry or a large-scale local government where organizational reorganization is frequently performed and authority rules tend to be complicated.

The user interface unit is a unit configured to provide a dashboard or an operation screen on which an administrator or a person in charge of personnel can confirm an account management status for each employee, a risk evaluation result by generative AI, an alert notification, an audit trail, and the like in real time through a Web browser or a dedicated application. For example, an administrator can perform an account lock in an emergency or an exceptional authority grant application from a terminal. It is also possible to manually register a transferring or leaving event of an employee from a terminal, and immediately trigger account management processing. It is also possible to download an audit report and submit it to an external auditor or a management layer. An operation manual for education, a tutorial video, and an FAQ automatic generation function are also provided. Specifically, the user interface unit adopts a GraphQL protocol for data communication with the server. The user interface unit sends a query defining a structure of necessary data from the terminal to the server. The user interface unit receives only JSON data without excess or deficiency from the server. The user interface unit caches the received data in a local storage or an indexed database of a browser. When a re-acquisition request for the same data occurs, the user interface unit reads the data from the cache without performing network communication. In drawing the dashboard, the user interface unit dynamically renders an authority grant status and a risk evaluation result as a graph in a Scalable Vector Graphics format using a data visualization library. On a manual event registration screen, the user interface unit asynchronously calls a validation API at the moment when focus of an input field is lost. The user interface unit verifies validity of an input value in real time, and immediately displays an error message on the screen. In the FAQ automatic generation function, the user interface unit sanitizes text data in an HTML format output from the generative AI execution unit. The user interface unit safely embeds the text data in a designated area of the screen after eliminating a malicious script tag in order to prevent a cross-site scripting attack. As a technical effect, the user interface unit minimizes a payload size of a network by adopting GraphQL, and realizes high-speed screen display even in an environment where a bandwidth is limited, such as a mobile line. The user interface unit dramatically improves a user's operation experience while reducing a load on the server by cache control and asynchronous validation on a client side. As a specific application field, the present system is used as a mobile-compatible management console for a security administrator who needs to perform an emergency account suspension operation using a smartphone or a tablet from outside.

The audit recording unit is a unit configured to record a history of all account management operations such as creation, deletion, authority change, grant/deprivation of access authority, API key issuance/revocation, and account lock/unlock of each account in chronological order, and automatically generate a report for audit response or internal control. For example, it automatically generates a dashboard on which who granted/deleted what authority and when can be confirmed at a glance. When an authority setting violating a security policy is detected, it automatically presents a corrective plan and notifies an administrator. When a legal compliance requirement is changed, it can propose an authority setting based on a new requirement, and automatically apply it through approval of an administrator. An audit trail is also integrated with an external system or a cloud storage, and long-term preservation or external audit response is also possible. Specifically, the audit recording unit hashes received log data using a cryptographic hash function. The audit recording unit includes a hash value of immediately preceding log data in current log data and hashes it again. The audit recording unit constructs a hash chain by repeating this processing, and cryptographically guarantees immutability of the log data. The audit recording unit generates a block in which log data for a certain period is collected. The audit recording unit arranges a hash value of each block in a Merkle tree structure, and calculates a root hash. The audit recording unit periodically writes this root hash to a smart contract of an external public blockchain network. In presenting a corrective plan, the audit recording unit simulates and executes a corrective command output from the generative AI execution unit in a temporary sandbox environment. The audit recording unit displays the corrective plan on a screen of an administrator after confirming that a simulation result does not impair stability of the system. In integration with a cloud storage, the audit recording unit converts log data into a column-oriented format such as a Parquet format. The audit recording unit asynchronously transfers the data to an object storage after compressing it. As a technical effect, the audit recording unit mathematically makes falsification of a log by an internal offender or an advanced cyber attack impossible by a combination of a hash chain and a Merkle tree, and maximizes completeness of an audit trail. The audit recording unit dramatically improves an execution speed of an aggregation query for log data of a multi-petabyte scale and reduces a storage cost by preservation in a column-oriented format. As a specific application field, the present system is used as an audit platform for automating proof of IT general control in a listed company complying with a strict financial reporting requirement such as the SOX Act.

The external system integration unit is a unit configured to integrate with various internal and external business systems and external services such as a mail system, a file sharing system, groupware, a project management system, a cloud infrastructure, a customer management system, an expense settlement system, an attendance management system, a remote access system, a VPN, a network device, and a physical entry/exit management system through API, batch processing, Webhook, and authentication integration such as SAML and OAuth, and collectively and automatically execute operations such as account creation, deletion, and authority change. For example, even when a new business system or external service is added, a structure capable of easily responding by API integration or plugin addition is adopted, and integration with an overseas base or a group company, multilingual support, time zone support, local legal regulation support, and the like are also automatically optimized. At the time of a failure, a state of an integration destination system is monitored, and at the time of a processing failure, a retry or an alternative procedure is automatically executed, and an administrator is notified. Specifically, the external system integration unit functions as an identity provider based on a Security Assertion Markup Language protocol. Upon receiving an authentication request from an external system, the external system integration unit confirms an authentication state of a user. When authentication is successful, the external system integration unit generates an assertion in an XML format including attribute information and authority information of the user. The external system integration unit assigns a digital signature to the assertion using a secret key, and sends it to the external system. The external system integration unit generates a JSON Web Token in integration using an OAuth protocol. The external system integration unit stores an expiration date and scope information in a payload of the token, and signs it with an HMAC algorithm. In integration by batch processing, the external system integration unit generates a CSV file, and encrypts and transfers it to an external file server using a Secure File Transfer Protocol. In state monitoring of an integration destination system, the external system integration unit periodically sends an HTTP GET request to a health check API. The external system integration unit records a response time and a status code, calculates a moving average, and evaluates soundness of the system. As an alternative procedure at the time of failure detection, when a main API endpoint is down, the external system integration unit dynamically switches a transmission destination of a request to a preset backup endpoint. As a technical effect, the external system integration unit eliminates a risk of managing a password for each individual system and safely constructs a single sign-on environment by using a standardized authentication protocol. The external system integration unit localizes an influence of a failure of an external system on processing of the present system by dynamic endpoint switching, and improves overall fault tolerance. As a specific application field, the present system is used as a provisioning hub in a mid-sized or small-to-medium-sized enterprise that uses a large number of SaaS applications for business and wants to automate assignment and collection of licenses accompanying joining and leaving of employees.

As described above, the system according to the present embodiment can highly accurately and efficiently automate account management of all employees including outsourced contract employees, and simultaneously realize reduction of a security risk, reduction of an operation load, strengthening of governance, improvement of audit response capability, reduction of an operation cost, securing of system expandability, and education and operation support by respective units operating in cooperation. Specifically, the present system executes each unit as an independent process on an operating system. The present system minimizes overhead of data transfer by using a shared memory or a named pipe for inter-process communication. The present system dynamically scales the number of worker threads according to the number of CPU cores of the server. The present system automatically increases or decreases the number of instances of a virtual machine in cooperation with an auto-scaling function of a cloud environment at a peak of traffic. The present system manages a connection pool of a database, and eliminates a delay required for establishing and disconnecting a connection. The present system periodically releases an unnecessary object on a memory by garbage collection, and prevents a memory leak. As a technical effect, the present system optimizes utilization efficiency of hardware resources, and maximizes transaction processing capability per unit time. The present system maintains responsiveness of the system even when a large number of sudden events occur by dynamic scaling, and brings downtime close to zero. As a specific application field, the present system is used as a backend system for integrally managing authority management of internal staff and access control of customer support in a consumer-oriented web service having millions of users.

### Implementation Steps

### Step 1: Registration and Update of Personnel Information

A personnel person in charge uses a Web browser or a dedicated application from a terminal to register or update detailed personnel information such as a name, an employee number, a joining date, a leaving date, a transferring history, an affiliated department, a project in charge, a job title, contact information, qualification information, an education history, a past personnel evaluation, an account authority history, and a system usage history of all employees such as outsourced contract employees, regular employees, dispatched employees, and part-time workers in a personnel information management unit. For example, when an employee A joins on Apr. 1, 2024, transfers from a sales department to an information system department on Jun. 1, 2024, and leaves on Dec. 31, 2024, all of these events are recorded in chronological order, and a related business system and authority information are also linked and managed for each event. Specifically, the terminal acquires character string data input by the personnel person in charge. The terminal executes a client-side format check using a regular expression on the input data. The terminal serializes the data that has passed the check into a JSON format payload. The terminal transmits a POST request to the personnel information management unit on a server using an HTTPS protocol. Upon receiving the request, the personnel information management unit deserializes the data in the payload. The personnel information management unit executes escape processing and sanitize processing on the input data in order to prevent an SQL injection attack. When confidential information such as a password is included, the personnel information management unit adds a salt and then hashes it using a SHA256 algorithm. The personnel information management unit starts a database transaction. The personnel information management unit issues an INSERT or UPDATE SQL statement to a basic information table, an affiliation history table, and an authority history table of the employee. After confirming that all SQL statements have been normally executed, the personnel information management unit commits the transaction and persists the data. The personnel information management unit returns an HTTP response including a status code indicating a processing result to the terminal. As a technical effect, the system physically blocks mixing of unauthorized data and strongly protects consistency of the database by double validation on the client side and the server side. The system completely prevents an inconsistent state in which only a part of data is updated even when a failure occurs during writing to a plurality of tables by transaction control. As a specific application field, the system is used as a secure and high-speed personnel master registration system in a major retail chain where hiring and leaving of thousands of part-time staff occur every month.

### Step 2: Detection of Personnel Event

An event detection unit monitors the database of the personnel information management unit in real time or at a predetermined cycle, and immediately detects an event when the event such as joining, leaving, or transferring occurs. For example, an employee whose scheduled joining date is today can be automatically extracted and detected as a joining event, an employee whose leaving date has arrived can be automatically detected and processed as a leaving event, or when a transferring date has arrived, it can be detected as a transferring event. When an event occurs, an email notification, a chat notification, a push notification, or the like is automatically transmitted to an administrator or a related party to prompt confirmation or approval of event content, input of additional information, or the like. Specifically, the event detection unit executes regular polling processing on the database of the personnel information management unit. The event detection unit monitors an update log of the database. The event detection unit extracts difference data from the update log. The event detection unit stores the extracted difference data in a time-series database. The event detection unit determines a type of the event from the difference data. The event detection unit generates an event object based on a determination result. The event object is a data structure including an employee identifier, an event type, an occurrence date and time, and a related attribute. The event detection unit transmits the generated event object to a message queue. The message queue is middleware for realizing asynchronous processing. The system transmits the event to a subsequent processing unit via the message queue. The system prevents a processing delay even when a large number of events occur simultaneously by this asynchronous communication. The system improves availability of the system. The event detection unit executes notification processing when an event occurs. The event detection unit acquires address information of a notification destination from the database. The event detection unit dynamically generates notification content. The event detection unit transmits an email using an SMTP protocol. The event detection unit transmits a notification to a chat system using an HTTP request. The event detection unit transmits a request to a push notification server. The system executes these notification processings in parallel threads. The system minimizes a notification delay. The system supports a quick response of the administrator. The system prevents an omission of processing of a personnel event. The system dramatically improves efficiency of personnel management in a large-scale organization.

### Step 3: Automatic Execution of Account Management Processing

An automatic account authority management unit automatically executes processing such as new creation, deletion, authority change, password initialization, account lock, access restriction, two-factor authentication setting, usage period setting, account activation/deactivation, group addition/deletion, role assignment, and API key issuance/revocation of an account of a corresponding employee for a plurality of business systems based on event information notified from the event detection unit. For example, at a time of a joining event, an account of a necessary business system is automatically newly created according to an affiliated department, a job title, and a project in charge of the employee, an initial password is issued, and the employee is automatically added to a necessary authority or group. At a time of a leaving event, the account of the corresponding employee is automatically deleted from all business systems, and for a system that cannot be deleted, the account is deactivated, an access authority is deprived, an API key or a token is revoked, and a physical entry/exit authority is also immediately stopped. At a time of a transferring event, an authority of an old department is automatically deleted, a necessary authority for a new department is automatically granted, and authority transfer in units of projects is also automatically performed. Specifically, the automatic account authority management unit receives an event object from the message queue. The automatic account authority management unit analyzes a payload of the event object. The automatic account authority management unit extracts an identifier of a target employee. The automatic account authority management unit searches a personnel information database using the employee identifier as a key. The automatic account authority management unit acquires detailed attribute information of the employee. The automatic account authority management unit drives a provisioning rule engine based on the attribute information. The rule engine holds a tree structure of conditional branching on a memory. The rule engine collates the affiliated department or the job title of the employee with a condition node. The rule engine acquires a list of necessary system identifiers from a matching leaf node. The automatic account authority management unit initializes an API client for each system identifier. The automatic account authority management unit transmits an HTTP POST request or PUT request to a RESTful API of each business system. The automatic account authority management unit includes a parameter for account creation or authority change in a body part of the request. The automatic account authority management unit verifies a response code from each system. The automatic account authority management unit records a processing success log when the response code indicates normality. The automatic account authority management unit executes retry processing when the response code indicates an error. The automatic account authority management unit gradually extends a retry interval using an exponential backoff algorithm. The system enhances fault tolerance against a temporary network failure or an overload of an integration destination system by this retry control. In a case of a leaving event, the automatic account authority management unit determines a deletion order using a dependency relationship graph. The automatic account authority management unit executes a topological sort of the dependency relationship graph. The automatic account authority management unit transmits an account deletion request in order from a lower system according to a sort result. The system prevents a referential integrity error between systems by this order control. The system completely eliminates an account deletion omission. The system significantly improves a security level of a company.

### Step 4: Optimization, Exception Processing, and Audit Support by Generative AI

A generative AI execution unit uses generative AI to comprehensively analyze a role, business content, an affiliated department, a past authority history, a system usage history of an employee, an authority hierarchical structure in an organization, a security policy, case data of past deletion omissions and authority grant mistakes, an audit trail, external threat information, a legal compliance requirement, and the like in the processing of the automatic account authority management unit, and executes an optimal account management procedure, exception processing, and automatic recording of an audit trail. For example, when deleting an account of a leaver, a past deletion omission pattern and a dependency relationship between systems are learned, a system having a high deletion omission risk is automatically specified, and deletion processing is intensively performed. For example, at a time of transferring, business content of an employee and authority requirements of old and new departments are analyzed, and an optimal authority grant/deletion procedure is automatically generated. For example, when an employee performs business across a plurality of projects, the generative AI analyzes a system usage status and an authority history for each project, and optimizes account deletion and authority deprivation necessary at a time of leaving in units of projects. Specific examples of a prompt sentence to be read by the generative AI include “A leaving event of an employee X has occurred. Specify accounts of all business systems used by X in the past, preferentially delete a system having a high deletion omission risk, and record a deletion result in an audit recording unit”, “An employee Y has transferred from a sales department to a development department. Analyze business content of Y and authority requirements of old and new departments, delete an unnecessary authority, and generate an optimal procedure for granting a necessary authority”, “An employee Z was performing business across a plurality of projects. Analyze a system usage status for each project of Z, and optimize account deletion and authority deprivation necessary at a time of leaving in units of projects”, and “Learn case data of past deletion omissions and authority grant mistakes, and automatically optimize a future account management procedure”. Specifically, the generative AI execution unit drives a neural network including a large language model. The neural network adopts a transformer architecture provided with a self-attention mechanism. The generative AI execution unit receives employee data and system environment data to be processed from the automatic account authority management unit. The generative AI execution unit converts the received data into a natural language prompt character string. The generative AI execution unit inputs the prompt character string to a tokenizer. The tokenizer converts the character string into a one-dimensional array of integer token IDs. The generative AI execution unit inputs the array of token IDs to an embedding layer. The embedding layer converts each token ID into a continuous value vector of several hundred dimensions. The generative AI execution unit inputs these vectors to a plurality of layers of encoder and decoder blocks. The neural network repeats a matrix product operation and application of a non-linear activation function in each layer. The neural network calculates a contextual dependency relationship of input data in a high-dimensional space. The neural network generates an appearance probability distribution of a next token as an output of a final layer. The generative AI execution unit selects a token having the highest probability from the probability distribution. The generative AI execution unit repeats this autoregressive generation process to construct an output character string. The generative AI execution unit parses the output character string as structured data. For example, input data at a time of a leaving event includes a time-series array of past access logs of an employee, an identifier list of a used system, and text data of a security policy document of an organization. The generative AI execution unit calculates a score of a deletion omission risk for each system from these input data. The generative AI execution unit specifies a system whose risk score exceeds a threshold value. The generative AI execution unit generates a list of the specified systems as output data. For example, input data at a time of a transferring event includes a two-dimensional array representing an authority matrix of old and new departments, and text data describing business content of an employee. The generative AI execution unit generates a difference list of an authority to be added and an authority to be deleted as output data from these input data. The automatic account authority management unit receives this output data. The automatic account authority management unit executes an actual API call according to a procedure described in the output data. The system resolves a complex dependency relationship of authorities that cannot be handled by a static rule base by this dynamic analysis by AI. The system substitutes a complex determination process manually performed by a human administrator as arithmetic processing of a computer. The system dramatically improves accuracy of authority setting. The system reduces a security risk due to an excessive authority grant.

### Step 5: Management, Approval, and Audit by User Interface

A user interface unit provides a dashboard and an operation screen on which an administrator or a personnel person in charge can confirm an account management status for each employee, a risk evaluation result by generative AI, an alert notification, an audit trail, and the like in real time through a Web browser or a dedicated application. The administrator can perform an emergency account lock or an exceptional authority grant application from a terminal, and can manually register a transferring or leaving event of an employee from the terminal to immediately trigger account management processing. An audit report can also be downloaded and submitted to an external auditor or a management layer. An operation manual for education, a tutorial video, and an FAQ automatic generation function are also provided. Specifically, the user interface unit functions as a Web server that hosts a front-end application. The user interface unit distributes a single-page application composed of a markup language and a script language to a client terminal. A Web browser of the client terminal executes the distributed application. The user interface unit establishes a constant connection with a back-end API server using a bidirectional communication protocol. The user interface unit receives an event or a state change occurring on a server side in real time via this bidirectional communication channel. The user interface unit updates a virtual document object model on a screen based on the received data. The user interface unit applies only a difference to an actual screen drawing tree. The system optimizes drawing performance of the screen by this difference update mechanism. The user interface unit draws various statistical information as a graph or a chart on a dashboard screen. The user interface unit visualizes a risk score calculated by the generative AI with a color code. The user interface unit highlights an item having a high risk score in red. The user interface unit receives an operation input from the administrator. When an emergency account lock button is pressed, the user interface unit immediately transmits a control command to a back end. The back-end server receives the control command and executes deactivation of a target account as top-priority interrupt processing. The user interface unit receives a generation request for an audit report. The user interface unit instructs a back-end form generation engine to output data in a document format or a comma-separated format. The user interface unit causes the client terminal to download the generated file. The system provides an intuitive and highly responsive operation environment. The system reduces a cognitive load on the administrator. The system improves a response speed in an emergency. The system greatly contributes to efficiency of audit business.

### Step 6: Audit Record, External System Integration, and Failure Response

An audit recording unit records a history of all account management operations such as creation, deletion, authority change, grant/deprivation of an access authority, API key issuance/revocation, and account lock/unlock of each account in chronological order, and automatically generates a report for audit response or internal control. An external system integration unit integrates with various internal and external business systems and external services such as a mail system, a file sharing system, groupware, a project management system, a cloud infrastructure, a customer management system, an expense settlement system, an attendance management system, a remote access system, a VPN, a network device, and a physical entry/exit management system through API, batch processing, Webhook, and authentication integration such as SAML and OAuth, and collectively and automatically executes operations such as account creation, deletion, and authority change. At a time of a failure, a state of an integration destination system is monitored, and when processing fails, a retry or an alternative procedure is automatically executed, and an administrator is notified. Specifically, the audit recording unit records all state transitions and operation events occurring in the system as immutable log data. The audit recording unit applies a cryptographic hash function to each log entry. The audit recording unit includes a hash value of an immediately preceding log entry in a current log entry. The audit recording unit makes falsification of log data mathematically detectable by this hash chain structure. The audit recording unit saves the generated log data in an append-only storage area. The external system integration unit adopts a microservice architecture. The external system integration unit operates an independent adapter module for each integration destination system. The external system integration unit executes an authorization flow with an external cloud service using a standard authorization protocol. The external system integration unit stores an acquired access token in a secure key management system. The external system integration unit establishes authentication integration of single sign-on using a markup language-based authentication protocol. The external system integration unit verifies an expiration date of a token when transmitting a request to an external system. When the token has expired, the external system integration unit automatically acquires a new access token using a refresh token. The external system integration unit provides an endpoint for receiving a callback request from an external system. The external system integration unit verifies a signature of a received payload and confirms validity of a transmission source. The system includes a failure detection module. The failure detection module periodically transmits a health check request to each external system. The failure detection module monitors a response time and a status code. When detecting an abnormality, the failure detection module applies a circuit breaker pattern. The system temporarily blocks request transmission to an abnormal system. The system prevents a cascading failure of the entire system. When an alternative processing path exists, the system automatically executes failover. The system realizes high fault tolerance and availability. The system enables integrated authority management in a complex multi-cloud environment.

### Specific Use Case

For example, assume an environment in a telecommunications industry or an IT-related company where a large number of outsourced contract employees participate on a project basis, and joining, transferring, and leaving frequently occur. In this case, a personnel information management unit creates a detailed database of a scheduled joining date, a scheduled leaving date, an affiliated department, a project in charge, a job title, a past transferring history, a system usage history, an authority history, and the like of an outsourced contract employee, and also links and manages a usage authority and an access range of a business system necessary for each project. For example, when a certain outsourced contract employee is assigned to a project of a sales department and account issuance for a plurality of business systems such as a sales support system, a customer management system, a file sharing system, and groupware is required, when a personnel person in charge registers a joining event, an event detection unit immediately detects this event, and an automatic account authority management unit collectively and automatically executes new account creation, initial password issuance, automatic addition to a necessary group or role, two-factor authentication setting, usage period setting, and the like for the business systems of the sales department through API integration or the like. Furthermore, a generative AI execution unit analyzes business content of the outsourced contract employee, an authority setting history of a past similar project, a security policy, an authority hierarchical structure in an organization, and the like, automatically generates an optimal authority grant pattern, and makes a determination for preventing an unnecessary authority grant or an excessive access authority. Specifically, the system manages dynamic authority assignment in units of projects using a graph database. The personnel information management unit stores an employee node, a project node, and a system authority node as a graph structure. The personnel information management unit defines a relationship between each node as an edge. The event detection unit detects an assignment event to a new project. The event detection unit transfers data of the assignment event to the automatic authority management unit. The automatic authority management unit issues a search query to the graph database. The automatic authority management unit extracts all system authority nodes connected to a target project node. The automatic authority management unit executes provisioning processing to each business system in parallel based on a list of the extracted authority nodes. The generative AI execution unit verifies validity of an authority before this provisioning processing. The generative AI execution unit generates a time-series vector representing a past project history of a target employee. The generative AI execution unit generates a feature vector representing a security requirement of a current project. The generative AI execution unit inputs these vectors to a neural network. The neural network calculates an inner product and non-linear transformation of the vectors using a multilayer perceptron. The neural network outputs a recommendation score for each authority. The generative AI execution unit specifies an authority whose recommendation score falls below a predetermined threshold value. The generative AI execution unit excludes the specified authority from a grant target list. For example, the generative AI execution unit has learned data of a similar project in which an information leakage incident occurred in the past. The generative AI execution unit determines that an external access authority to a specific file sharing system is unnecessary based on a learning result thereof. The system overcomes a limitation of static role-based access control by this dynamic filtering by AI. The system strictly applies a principle of least privilege. The system achieves both a quick launch of a project and maintenance of high security.

For example, when the same employee transfers from a sales department to an information system department due to an end of a project, an event detection unit detects a transferring event, an automatic account authority management unit automatically deletes an authority of a sales support system or a customer management system, newly creates an account of a development support system, a cloud infrastructure, or a project management system necessary in the information system department, and automatically grants an appropriate administrator authority or access authority. A generative AI execution unit comprehensively analyzes a change in business content or a role before and after transferring, a past transferring case, authority consistency between systems, a security risk evaluation, and the like, and automatically generates an optimal authority transfer procedure so that duplication or contradiction of authorities does not occur. For example, when authority transfer in units of projects is necessary, generative AI analyzes a system usage status and an authority history for each project, automatically deprives an authority that becomes unnecessary after transferring, and grants only a newly necessary authority. Specifically, the event detection unit detects a change in a department code from an update log of a personnel database. The event detection unit notifies an automatic authority management unit of this change as a transferring event. The automatic authority management unit acquires an authority set related to a department before transferring and an authority set related to a department after transferring from a database. The automatic authority management unit calculates a logical difference between both authority sets. The automatic authority management unit generates a list of authorities to be deleted and a list of authorities to be added. The generative AI execution unit optimizes this difference list. The generative AI execution unit receives a natural language text describing business content of an employee as input data. The generative AI execution unit extracts a keyword or a role of business from the text using a natural language processing model. The generative AI execution unit collates an extracted feature amount with an authority matrix of a system. The generative AI execution unit specifies an exceptional authority that continues to be necessary even after transferring. For example, the generative AI execution unit detects from text analysis that a specific customer response project continues even in a case of transferring from a sales department to an information system department. The generative AI execution unit generates output data recommending to retain a partial authority of a customer management system. The generative AI execution unit returns this output data to the automatic authority management unit in a structured data format. The automatic authority management unit parses the structured data and determines a final provisioning plan. The automatic authority management unit sequentially executes an API request to each system according to the determined plan. The system prevents business stoppage due to excess or deficiency of an authority by this processing. The system eliminates a security hole due to remaining of an unnecessary authority. The system dramatically reduces a workload of an IT administrator accompanying a complex organizational change.

In addition, when a leaving event occurs, the event detection unit detects an arrival of a leaving date, and the automatic account authority management unit collectively and automatically executes account deletion and deactivation, revocation of an API key and a token, suspension of a physical entry/exit authority, and the like for all business systems. The generative AI execution unit analyzes case data of past deletion omissions and authority grant mistakes, a dependency relationship between systems, a system usage history of a leaver, an external service integration status, and the like, preferentially deletes a system having a high deletion omission risk, and automatically records a deletion result and an exception processing content in an audit recording unit. For example, when the leaver has used a plurality of cloud infrastructures and external services, the generative AI executes account deletion and authority change for all the external services through API integration to prevent a deletion omission and an authority grant mistake. Furthermore, when leaving is suddenly decided, the generative AI immediately locks accounts of all the systems, and automatically sends an alert prompting an administrator for an emergency response. Specifically, the present event detection unit executes batch processing for comparing a current date with a scheduled leaving date on a personnel database every day. The present event detection unit extracts a record having a matching date. The present event detection unit registers the extracted record in a queue as a leaving event. The present automatic authority management unit acquires the leaving event from the queue. The present automatic authority management unit collects all account identifiers associated with a target employee from an integrated database. The present generative AI execution unit receives the collected list of accounts and a dependency relationship graph of each system as an input. The present generative AI execution unit calculates an importance degree of each node and an influence degree at a time of deletion using a graph neural network. The present generative AI execution unit outputs a priority list for performing deletion in descending order of the influence degree of the system. For example, the present generative AI execution unit orders to delete an account of an authentication provider serving as an infrastructure of single sign-on last, and to delete an account of an individual business application first. The present automatic authority management unit calls a deletion API according to this priority list. The present automatic authority management unit monitors a response of the API, and immediately changes a password of the account to a random character string to put the account into a locked state when the deletion fails. When receiving an emergency event such as sudden leaving or disciplinary dismissal, the present system bypasses normal order control. The present system asynchronously and simultaneously broadcasts an account deactivation command to all the systems. The present system minimizes a risk of malicious internal fraud and data taking-out by this emergency processing. The present system realizes complete automation of leaving processing and reliable saving of an audit trail. The present system strongly supports a compliance requirement of a company.

In such a use case, specific examples of a prompt sentence to be read by the generative AI include “A leaving event of an employee X has occurred. Identify accounts of all business systems used by X in the past, preferentially delete a system having a high deletion omission risk, and record a deletion result in the audit recording unit”, “An employee Y has transferred from a sales department to an information system department. Analyze business content of Y and authority requirements of old and new departments, and generate an optimal procedure for deleting an unnecessary authority and granting a necessary authority”, “An employee Z has performed business across a plurality of projects. Analyze a system usage status for each project of Z, and optimize account deletion and authority deprivation necessary at a time of leaving in units of projects”, and “Learn case data of past deletion omissions and authority grant mistakes, and automatically optimize a future account management procedure”. Specifically, the present generative AI execution unit includes a template engine configured to dynamically construct these prompt sentences. The present template engine embeds a specific variable in a placeholder according to a type of an event and an attribute of a target person. The present generative AI execution unit passes the constructed prompt sentence to an input interface of a large language model. The present large language model is fine-tuned using a company-specific account management manual and a past incident report in addition to pre-learning. The present large language model analyzes a context of the input prompt sentence by a self-attention mechanism. The present large language model calculates a relevance between embedding vectors of respective words. The present large language model compares a pattern of a past deletion omission case with a current situation. The present large language model calculates a similarity score. When the similarity score exceeds a certain value, the present large language model generates a warning message for a specific system. The present large language model generates structured data including a list of specific commands to be executed and a parameter set of an API request as an output. The present system passes this structured data to a subsequent automatic execution module. The present system seamlessly integrates a flexible instruction by a natural language and strict execution by a program. The present system enables an administrator to apply advanced automation logic without writing a complex script. The present system significantly reduces an operation and maintenance cost of the system.

In this way, the system of the present invention automatically and optimally executes account creation, deletion, authority change, and the like for a plurality of business systems in accordance with a personnel event such as joining, transferring, and leaving of an employee, and by utilizing generative AI, comprehensively analyzes a past operation history, a security policy, a dependency relationship between systems, a change in business content, an external service integration status, and the like, prevents a deletion omission and an authority grant mistake, and can realize advanced account management including automatic recording of an audit trail and an emergency response. Specifically, the present system functions as an integrated platform in which an event-driven architecture and a machine learning model are tightly coupled. The present system sequentially activates a microservice group triggered by an update of a personnel database. The present system provides an abstraction layer that absorbs a difference in API specifications of each business system. The present system incorporates an inference engine by the generative AI into a provisioning pipeline. The present inference engine constructs a high-dimensional feature space from input attribute data and history data. The present inference engine executes a clustering and classification task on the feature space. The present inference engine probabilistically derives an optimal authority configuration. The present system executes deterministic system control based on this inference result. The present system records an entire history of state transitions in a cryptographically protected data store. The present system accomplishes authority management with speed and accuracy exceeding limits of human cognitive ability and manual work by this series of processing loops. The present system simultaneously enhances confidentiality, integrity, and availability of information security. The present system provides an indispensable security infrastructure in a modern corporate environment having a large-scale and complex IT infrastructure. The present system brings about an epoch-making improvement that improves autonomy and reliability of computer technology itself.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments for carrying out the present invention will be described in detail extremely specifically and exhaustively, taking an authority management automation system in a data center as an example. The system of the present embodiment is configured to include a personnel information management unit, an event detection unit, an automatic authority management unit, a generative AI execution unit, an audit recording unit, a user interface unit, and an external system integration unit.

The personnel information management unit centrally manages all attribute information as a database, such as a name, a facial photograph, contact information, an affiliated organization, an employment form, a contract period, a scheduled entry date and time, a scheduled exit date and time, work content, a project in charge, a past work history, a past authority history, a past security incident history, an education history, qualification information, a health checkup history, emergency contact information, and site manager information of persons in various positions such as all operation administrators, maintenance workers, external contractors, security persons in charge, cleaners, facility inspectors, temporary workers, and night workers who enter and exit the data center. For example, when an external contractor A is scheduled to enter for server maintenance work from 9:00 to 17:00 on Jul. 1, 2024, a name, an affiliated company, a scheduled work date and time, work content, a past entry/exit history, an authority granted in the past and its valid period, a past security incident history, a past education attendance history, presence or absence of a health checkup, and the like of the worker are recorded in detail. For example, even when the same person works in a plurality of projects or a plurality of data center bases, all work histories and authority histories can be integrally managed. For example, attributes and histories can be individually managed even for a person having a special work form or authority requirement, such as an emergency response personnel or a night worker. For example, detailed entry/exit control and authority setting are possible even for a person who should be permitted to access only a limited area or time zone, such as a cleaner or a facility inspector. Specifically, the present personnel information management unit constructs a hybrid data store combining a relational database and a document-oriented database. The present personnel information management unit stores fixed-form data such as a name and an affiliation in a relational table. The present personnel information management unit stores non-fixed-form data such as image data of a facial photograph and a past work history as a document format. The present personnel information management unit applies a convolutional neural network to the facial photograph data. The present personnel information management unit extracts a facial feature point from the image, and generates a feature vector of several hundred dimensions. The present personnel information management unit indexes and saves this feature vector in a vector database. The present system executes facial authentication processing at a time of entry at high speed and with high accuracy using this feature vector. The present personnel information management unit develops a graph structure having attribute information of each person as a node and a relationship with a project or an affiliated organization as an edge on a memory. The present personnel information management unit instantaneously searches for a list of all workers belonging to a specific project or a set of persons having an access right to a specific area using this graph structure. For example, the present system dynamically generates a special access profile that bypasses a normal approval flow for a person flagged as an emergency response personnel. The present system sets a logical partition that does not grant any unlocking authority of a server rack to a cleaner, and grants only a passage authority of an aisle in a specific time zone. The present system realizes such complex attribute management by optimizing a data structure. The present system flexibly responds to a strict access requirement of the data center.

The event detection unit monitors event information such as entry, exit, work content change, emergency response, failure occurrence, temporary work permission, work interruption, work extension, and work cancellation from the personnel information management unit and a work schedule management system, a physical entry/exit management system, a facial authentication gate, an IC card reader, a biometrics authentication device, an on-site reception terminal, a work instruction system, an emergency notification system, and the like in real time or at a predetermined cycle, and immediately detects an occurrence of an event. For example, when the external contractor A passes through an entry gate for server maintenance work, an entry event is detected from a facial authentication log, an IC card authentication log, and an operation history of the reception terminal. For example, when work content is changed from server maintenance to network device setting in the middle, a work change event is detected from update information of the work instruction system and an approval record of a site manager. For example, when passing through an exit gate after work is completed, an exit event is detected from a log of the physical entry/exit management system. For example, when entry is temporarily permitted at a time of failure occurrence, an emergency entry event is detected from the emergency notification system and the approval record of the site manager. For example, even when work is completed earlier than scheduled or conversely extended, an event is detected from update information of the schedule management system, and subsequent processing is triggered. Specifically, the present event detection unit receives streaming data from various sensors and authentication devices arranged in the data center. The present event detection unit processes a high-throughput data stream using a distributed messaging system. The present event detection unit analyzes frame data of a camera video transmitted from the facial authentication gate in real time. The present event detection unit calculates a cosine similarity between a facial feature vector extracted from the frame data and a feature vector saved in the personnel information management unit. When the similarity exceeds a threshold value, the present event detection unit generates an event object of identity verification success. The present event detection unit decodes a serial number of a wireless tag read from the IC card reader. The present event detection unit collates the serial number with a record of a database, and generates an entry event. The present event detection unit applies a change data capture technology to a database of the work instruction system. The present event detection unit monitors a transaction log, and immediately detects an update of work content. The present event detection unit groups related events generated from a plurality of sources by a time frame. The present event detection unit infers a meaningful business event from a combination of simple events using a complex event processing engine. For example, when a passage event of an entry gate and an unlocking event of a specific server rack occur continuously, the present event detection unit integrates them as a maintenance work start event. The present system accurately maps a situation of a physical space to a digital space by this advanced event processing. The present system imparts a real-time situational awareness capability to a computer system.

The automatic authority management unit automatically executes processing such as account creation, deletion, authority grant/deprivation/change, access restriction, account lock, API key issuance/revocation, usage period setting, two-factor authentication setting, access range restriction, operation log acquisition setting, and alert notification setting of a corresponding person for all systems in the data center, such as a physical entry/exit management system, a surveillance camera management system, a network device management system, a server management system, a configuration management system, a power supply management system, a facility monitoring system, a cloud infrastructure management system, a storage management system, a backup management system, a security monitoring system, an access log management system, a VPN management system, a remote access management system, and an API management system, based on the event information notified from the event detection unit. For example, a physical entry/exit authority to a server room, an unlocking authority of a corresponding rack, an access authority to a server management console, a viewing authority of a surveillance camera video, a setting change authority of a necessary network device, an operation authority of a power supply management system, a viewing authority of a facility monitoring system, and the like are automatically granted to a worker who has entered for server maintenance work. For example, when work content is changed, an unnecessary authority is immediately deprived, and only a newly necessary authority is additionally granted. For example, when an exit event occurs, an authority of a corresponding person is immediately deprived from all related systems, and an account is deactivated or deleted. For example, an authority consistency check is also automatically executed so that duplication or contradiction of authorities among a plurality of bases or a plurality of systems does not occur. For example, for the API management system and the remote access management system, a temporary API key and a VPN account limited to a work period can be automatically issued, and immediately revoked after work is completed. For example, for the backup management system and the storage management system, an access range and an operation authority according to a specific project and work content are finely set to prevent access to unnecessary data and an erroneous operation. Specifically, the present automatic authority management unit implements a dynamic policy evaluation engine based on a principle of a zero trust architecture. When receiving an event object from the event detection unit, the present automatic authority management unit collects current context information of a target person. The present context information includes position information, a time zone, a security state of a device, and a network route. The present automatic authority management unit inputs the context information and a requested access authority to a policy engine. The present policy engine determines propriety of access permission by a logical operation using an attribute-based access control model. When access is permitted, the present automatic authority management unit dynamically generates a provisioning script for a target system. The present automatic authority management unit establishes a secure communication channel with a target server and network device using an encrypted communication protocol. The present automatic authority management unit executes the generated script on a target device, and performs local account creation and firewall rule addition. The present automatic authority management unit generates a temporary access token in a signed token format for the API management system. The present automatic authority management unit embeds a work end time as an expiration date in a payload of the token. The present automatic authority management unit defines a list of endpoints accessible to the token as a scope. The present system enables authority verification in a distributed system without inquiring of a central server by using this cryptographically signed token. When receiving a work end event, the present system immediately updates a revocation list of tokens, and transmits a command for deactivating a passage authority of a physical gate to a controller. The present system realizes seamless and strict access control beyond a boundary between physical and logical.

The generative AI execution unit comprehensively analyzes all related information such as work content of a worker, a past work history, a security policy, an access requirement for each system, an on-site risk level, case data of deletion omissions and authority grant mistakes, external threat information, a legal compliance requirement, an audit trail, an authority hierarchical structure in an organization, a past incident response history, an approval history of a site manager, an education history and qualification information of a worker, and a health checkup history in the processing of the automatic authority management unit, and autonomously determines and executes an optimal authority set, exception processing, automatic recording of an audit trail, immediate response in an emergency, and the like. For example, a prompt sentence such as “A worker B enters for network device setting work. Propose an optimal authority set considering a past work history of B, a current security policy, an authority requirement of a network device management system, an on-site risk level, an education history and qualification information of B, and a past incident response history” is input to the generative AI, and the AI automatically generates a minimum necessary and appropriate authority set. For example, at a time of an exit event, using a prompt sentence such as “An exit event of a worker C has occurred. Identify all system authorities granted to C today, preferentially deprive an authority for a system having a high deletion omission risk, and record an audit trail”, the AI considers a past deletion omission case, a dependency relationship between systems, an on-site risk level, and external threat information, and realizes reliable authority deprivation. For example, when work content is changed in the middle, using a prompt sentence such as “Work content of a worker D has been changed from server maintenance to network setting. Consider new work content of D, a past work history, a security policy, an authority requirement of a network device management system, and an education history and qualification information of D, delete an unnecessary authority, and add a necessary authority”, the AI recalculates an optimal authority set, and the automatic authority management unit immediately updates an authority of each system. For example, at a time of an emergency response or failure occurrence, the AI automatically determines temporary authority grant and access range expansion based on an approval of a site manager and information of an emergency notification system, and executes immediate authority deprivation after work is completed. Specifically, the present generative AI execution unit operates on a parallel computing cluster hosting a large language model corresponding to a multimodal input. The present generative AI execution unit simultaneously receives not only text data but also an image tensor of a surveillance camera and time-series array data of network traffic as an input. The present generative AI execution unit projects these heterogeneous data onto a common latent space vector. The present generative AI execution unit calculates a complex correlation among an attribute of a worker, a past history, and a current environmental context using a self-attention mechanism of a transformer. For example, the present generative AI execution unit tokenizes an input prompt sentence, and generates an embedding vector of each token. The present generative AI execution unit combines a vector representation of a similar case retrieved from a past incident database as a context of a prompt. The present generative AI execution unit executes inference using this expanded context. The present generative AI execution unit generates structured data including a list of authorities to be granted, a valid period of each authority, and a risk evaluation score as an output. For example, when work content is changed, the present generative AI execution unit analyzes a difference in work procedure manual texts before and after the change. The present generative AI execution unit identifies a newly necessary port number and IP address range. The present generative AI execution unit automatically generates a setting change command of a firewall. In an emergency, the present generative AI execution unit immediately starts inference triggered by an alert signal from an abnormality detection model. The present generative AI execution unit calculates a network isolation procedure for minimizing damage and a temporary privileged access grant procedure to an emergency response team in several milliseconds, and instructs the automatic authority management unit to execute them. The present system eliminates human judgment delay by this AI-driven dynamic control. The present system maximizes safety and agility in operation of a data center.

The audit recording unit records a history of all account management operations such as creation, deletion, authority change, grant/deprivation of an access authority, API key issuance/revocation, account lock/unlock, an access log, an operation log, an alert notification, exception processing, and an emergency response history of each account in chronological order, and automatically generates a report for an audit response and internal control. For example, a dashboard is automatically generated in which who granted/deleted what authority and when, which site manager performed what approval for which worker, in which system a deletion omission or an authority grant mistake occurred, and what exception processing or emergency response was executed can be confirmed at a glance. For example, when an authority setting violating a security policy is detected, a corrective plan is automatically presented and notified to an administrator. For example, when a legal compliance requirement is changed, an authority setting based on a new requirement can be proposed and automatically applied through an approval of an administrator. For example, an audit report and trail data are automatically generated for reporting to an external auditor and a management layer, and encryption, long-term saving, and external storage integration are also possible as necessary. Specifically, the present audit recording unit constructs an immutable data store applying a distributed ledger technology. The present audit recording unit packages all account operation events occurring in the system as a transaction. The present audit recording unit generates a block by putting a plurality of transactions together. The present audit recording unit includes a hash value of a previous block in a header of a current block using a cryptographic hash function. The present audit recording unit makes falsification and deletion of a past audit log mathematically impossible by this blockchain structure. The present audit recording unit executes real-time stream processing on recorded log data. The present audit recording unit scores a behavior deviating from a normal operation pattern using an abnormality detection algorithm. When a score exceeds a threshold value, the present audit recording unit fires an alert event indicating a possibility of a security incident. The present audit recording unit periodically aggregates accumulated log data, and constructs a multidimensional data cube. The present audit recording unit generates an audit report from an arbitrary perspective at high speed using this data cube. The present audit recording unit automatically applies masking processing and anonymization processing of data at a time of report generation. The present audit recording unit satisfies a legal compliance requirement such as a personal information protection law. The present audit recording unit encrypts a generated report file by a public key cryptosystem. The present audit recording unit asynchronously transfers the encrypted file to an object storage on a cloud, and satisfies a requirement of long-term saving. The present system provides complete transparency and traceability. The present system dramatically reduces a proof burden for an external audit.

The user interface unit provides a dashboard and an operation screen on which an administrator and a site person in charge can confirm an account management status for each worker, a risk evaluation result by the generative AI, an alert notification, an audit trail, an operation history, an exception processing history, an emergency response history, and the like in real time through a Web browser and a dedicated application. For example, an administrator can perform an account lock in an emergency and an exceptional authority grant application from a terminal. For example, work content change and an exit event can be manually registered from a terminal, and account management processing can be immediately triggered. For example, an audit report can be downloaded and submitted to an external auditor and a management layer. An operation manual for education, a tutorial video, and an FAQ automatic generation function are also provided. For example, a site person in charge can confirm a health checkup history and qualification information of a worker, and display a warning when necessary education and qualification are unacquired. Specifically, the present user interface unit provides a single page application constructed using a modern front-end framework. The present user interface unit maintains a bidirectional communication connection with a back-end server, and receives a push notification of a state change in milliseconds. The present user interface unit reflects a received data stream in a state management store on a memory. The present user interface unit detects a change in state, reconstructs a virtual screen tree, and instructs a drawing engine of a browser to perform differential rendering. The present user interface unit draws a floor map in the data center as 3D graphics. The present user interface unit superimposes and displays position information and an authority state of each worker as a real-time icon on the map. The present user interface unit visualizes a risk score calculated by the generative AI as a heat map. When an administrator clicks a specific icon, the present user interface unit displays detailed attribute information and an operation history of the worker in a modal window. The present user interface unit includes a dedicated component configured to receive a command input of an emergency account lock. The present component displays a two-step authentication prompt for preventing an erroneous operation. The present user interface unit transmits an input authentication code to a back end, and triggers immediate execution. The present user interface unit includes an interactive interface using natural language processing. The present interactive interface analyzes a question text from a site person in charge, extracts an optimal answer from a knowledge database, and displays the optimal answer. The present system enables intuitive grasping of a complex authority state by an advanced information visualization technology. The present system strongly supports decision-making of an administrator.

An external system integration unit integrates with various internal and external business systems and external services such as a physical entry/exit management system, a surveillance camera management system, a network device management system, a server management system, a configuration management system, a power management system, a facility monitoring system, a cloud infrastructure management system, a storage management system, a backup management system, a security monitoring system, an access log management system, a VPN management system, a remote access management system, and an API management system through authentication integration such as an API, batch processing, Webhook, SAML, and OAuth, and collectively and automatically executes operations such as account creation, deletion, and authority change. For example, even when a new business system or external service is added, a structure capable of easily responding by API integration or plugin addition is adopted, and integration with a plurality of bases or group companies, multilingual support, time zone support, local law and regulation support, and the like are also automatically optimized. For example, in the event of a failure, a state of an integration destination system is monitored, and when processing fails, a retry or an alternative procedure is automatically executed, and an administrator is notified. For example, when a contract of an external contractor ends or a qualification expires, an authority is automatically deprived from all related systems, and an account is deactivated. Specifically, the external system integration unit functions as an API gateway extending a concept of an enterprise service bus. The external system integration unit manages an adapter group that absorbs differences in communication protocols and data formats with each integration destination system. The external system integration unit corresponds to various communication protocols. The external system integration unit dynamically converts a data structure of a payload into a schema requested by a target system when transmitting a request to an external system. The external system integration unit executes a standard authorization code flow and securely acquires an access right to an external cloud service. The external system integration unit holds the acquired access token in an encrypted cache on a memory. The external system integration unit detects a timeout due to an instantaneous interruption of a network or an overload of an external system. The external system integration unit automatically executes retry processing using an exponential backoff algorithm when an error occurs. The external system integration unit moves a message to a save queue when a specified number of retries fail. The external system integration unit asynchronously notifies the administrator of an alert. The external system integration unit integrates with an external threat intelligence service by a callback mechanism. The external system integration unit multicasts a command for session disconnection and account deactivation to all related adapters at the moment of receiving an indicator of compromise for a specific IP address or account. The system guarantees transaction consistency in a heterogeneous environment by this robust integration mechanism. The system maximizes fault tolerance and a security response speed of the entire system.

As described above, the embodiment of the present invention can simultaneously realize reduction of a security risk, operational efficiency improvement, prevention of a human error, automatic recording of an audit trail, immediate response in an emergency, operation cost reduction, securing of system expandability, education/operation support, legal compliance, external audit response, securing of on-site safety, burden reduction of an on-site person in charge, efficiency improvement of external contractor management, improvement of response capability at the time of a failure, homogenization of work quality, and standardization of on-site operation by automatically optimizing and managing access authorities on both physical and logical sides based on analysis of generative AI in conjunction with all entry/exit and work events in a data center. Specifically, the system functions as a cyber-physical system that integrally processes sensor data in a physical space and an access log in a logical space. The system combines an event-driven asynchronous processing pipeline and an advanced inference engine using a large language model. The system mathematically derives an optimal authority configuration from input multidimensional context data. The system instantaneously applies the derived authority configuration to tens to hundreds of heterogeneous system groups via a microservice architecture. The system completely eliminates human intervention in this series of processing. The system solves a fundamental problem of a setting mistake and a delay in judgment due to manual work by computer technology. The system guarantees data integrity by recording an audit log applying blockchain technology. The system dynamically and strictly applies a principle of least privilege in an environment requiring extremely strict security such as a data center by a combination of these technical means. The system reduces a risk of unauthorized access to the utmost limit. The system dramatically reduces a workload of an operation administrator and promotes efficient use of computer resources. The system achieves optimization of security and operational efficiency at a level unreachable by a conventional method.

### System Configuration

The system according to the present embodiment comprises a personnel information management unit, an event detection unit, an automatic authority management unit, a generative AI execution unit, an audit recording unit, a user interface unit, and an external system integration unit. The personnel information management unit of the system centrally manages all attribute information as a database, such as a name, a facial photograph, contact information, an affiliated organization, an employment form, a contract period, a scheduled entry date and time, a scheduled exit date and time, work content, a project in charge, a past work history, a past authority history, a past security incident history, an education history, qualification information, a health checkup history, emergency contact information, and on-site person in charge information of an operation administrator, a maintenance worker, an external contractor, a security person in charge, a cleaner, an equipment inspector, a temporary worker, a night worker, and the like who enter and exit a data center. For example, when an external contractor enters for server maintenance work, a name, an affiliated company, a scheduled work date and time, work content, a past entry/exit history, an authority granted in the past and its valid period, a past security incident history, an education attendance history, presence or absence of a health checkup, and the like of the worker are recorded in detail. For example, even when the same person works in a plurality of projects or a plurality of data center bases, all work histories and authority histories can be integrally managed. For example, attributes and histories can be individually managed even for a person having a special work form or authority requirement, such as an emergency response personnel or a night worker. For example, detailed entry/exit control and authority setting are possible even for a person whose access should be permitted only in a limited area or time zone, such as a cleaner or an equipment inspector. Specifically, the system deploys each processing unit as an independent process on a memory space, and realizes high-speed data integration using inter-process communication. The personnel information management unit adopts a distributed relational database management system. The personnel information management unit distributes and stores attribute records of tens of thousands of persons in a plurality of storage nodes. The personnel information management unit assigns a unique hash value to each record. The personnel information management unit enables distributed arrangement and high-speed search of data using this hash value. The personnel information management unit saves large-capacity binary data such as a facial photograph and biometrics data in an object storage. The personnel information management unit links its reference identifier to a record in the database. The personnel information management unit stores a past work history and authority history in a time-series database. The personnel information management unit constructs an index using a time stamp as a primary key. The system guarantees response performance on the order of milliseconds to a high-frequency read request from the event detection unit or the automatic authority management unit by this optimized data structure. For example, the system activates a background process when a scheduled entry time of an external contractor approaches. The system pre-reads a flag of a past security incident history or an education attendance history of a target person onto a memory. The system immediately executes authority evaluation without a delay of disk reading at the moment when an actual entry event occurs. The system processes a huge amount of access requests in a large-scale data center without delay by this technical improvement of data management. The system prevents congestion at a physical gate, and achieves both smooth entry/exit and a strict security check.

The event detection unit monitors event information such as entry, exit, work content change, emergency response, failure occurrence, temporary work permission, work interruption, work extension, and work cancellation from the personnel information management unit and a work schedule management system, a physical entry/exit management system, a facial recognition gate, an IC card reader, a biometrics authentication device, an on-site reception terminal, a work instruction system, an emergency notification system, and the like in real time or at a predetermined cycle, and immediately detects an occurrence of an event. For example, when an external contractor passes through an entry gate for server maintenance work, an entry event is detected from a facial recognition log, an IC card authentication log, or an operation history of a reception terminal. For example, when work content is changed from server maintenance to network device setting in the middle, a work change event is detected from update information of a work instruction system or an approval record of an on-site person in charge. For example, when passing through an exit gate after completion of work, an exit event is detected from a log of a physical entry/exit management system. For example, when entry is temporarily permitted at the time of failure occurrence, an emergency entry event is detected from an emergency notification system or an approval record of an on-site person in charge. For example, even when work is completed earlier than scheduled or conversely extended, an event is detected from update information of a schedule management system, and subsequent processing is triggered. Specifically, the event detection unit acquires raw data transmitted from each edge device and integration system as a time-series numerical vector. The event detection unit executes preprocessing of noise removal and normalization on the acquired raw data. The event detection unit converts the preprocessed data into a multidimensional tensor. The event detection unit stores the converted multidimensional tensor in a queue on a memory. The event detection unit divides a data stream stored in the queue for each certain time window. The event detection unit inputs the divided data chunk to a feature extraction module. The feature extraction module extracts a spatial feature using a convolutional neural network. The feature extraction module extracts a temporal feature using a long short-term memory network. The event detection unit inputs the extracted feature vector to an anomaly detection algorithm. The anomaly detection algorithm calculates a Mahalanobis distance and scores a degree of deviation from a normal state. The event detection unit determines that a state transition event has occurred when the calculated score exceeds a preset threshold value. The event detection unit classifies an event type based on a determination result. The event detection unit generates structured data including label data indicating the classified event type and an occurrence time. The event detection unit transmits the generated structured data to a subsequent automatic authority management unit using an asynchronous communication protocol. The system accurately captures a minute state change overlooked by simple rule-based threshold determination by using such a vector operation in a high-dimensional space. The system dramatically improves accuracy of event detection by this processing. The system prevents waste of calculation resources of subsequent processing by reducing false detection. The system exhibits an extremely high technical effect in a use case such as entry/exit management of a data center or worker flow line monitoring of a large-scale factory.

The automatic authority management unit automatically executes processing such as account creation, deletion, authority grant/deprivation/change, access restriction, account lock, API key issuance/revocation, usage period setting, two-factor authentication setting, access range restriction, operation log acquisition setting, and alert notification setting of a corresponding person for all systems in a data center such as a physical entry/exit management system, a surveillance camera management system, a network device management system, a server management system, a configuration management system, a power management system, a facility monitoring system, a cloud infrastructure management system, a storage management system, a backup management system, a security monitoring system, an access log management system, a VPN management system, a remote access management system, and an API management system based on the event information notified from the event detection unit. For example, a physical entry/exit authority to a server room, an unlocking authority of a corresponding rack, an access authority to a server management console, a viewing authority of a surveillance camera video, a setting change authority of a necessary network device, an operation authority of a power management system, a viewing authority of a facility monitoring system, and the like are automatically granted to a worker who has entered for server maintenance work. For example, when work content is changed, an unnecessary authority is immediately deprived, and only a newly necessary authority is additionally granted. For example, when an exit event occurs, an authority of a corresponding person is immediately deprived from all related systems, and an account is deactivated or deleted. For example, an authority consistency check is also automatically executed so that duplication or contradiction of authorities among a plurality of bases or a plurality of systems does not occur. For example, for an API management system or a remote access management system, a temporary API key or VPN account limited to a work period can be automatically issued, and immediately revoked after completion of work. For example, for a backup management system or a storage management system, an access range or an operation authority according to a specific project or work content is finely set to prevent access to unnecessary data or an erroneous operation. Specifically, the automatic authority management unit extracts an identifier of a target user and an event type from the received structured data. The automatic authority management unit executes an inquiry to a distributed database using the extracted identifier as a key. The automatic authority management unit acquires a state vector indicating a current authority state of the target user. The automatic authority management unit loads an authority change template corresponding to the event type onto a memory. The automatic authority management unit executes a matrix operation of the state vector and the authority change template. The automatic authority management unit calculates a difference vector between an authority to be added and an authority to be deleted by this matrix operation. The automatic authority management unit converts the calculated difference vector into an API request format interpretable by each target system. The automatic authority management unit asynchronously transmits the converted API request to each system using a parallel processing thread. The automatic authority management unit monitors a response status code from each system. The automatic authority management unit updates the state vector of the distributed database at a time point of receiving normal responses from all systems. The automatic authority management unit executes retry processing using an exponential backoff algorithm when a communication error or a timeout occurs. The automatic authority management unit executes rollback processing to prevent authority inconsistency when the retry reaches an upper limit. The system adopts an unconventional method of managing an authority state on a vector space and calculating a difference by a matrix operation. The system completes authority change processing for thousands of systems in units of milliseconds by this method. The system completely eliminates an authority setting mistake due to human manual work. The system brings about a technical effect of maintaining a security level and dramatically reducing an operation cost in a use case such as a zero trust network environment or dynamic access control of a large-scale cloud infrastructure.

The generative AI execution unit comprehensively analyzes all related information such as work content of a worker, a past work history, a security policy, an access requirement for each system, an on-site risk level, case data of deletion omissions and authority grant mistakes, external threat information, a legal compliance requirement, an audit trail, an authority hierarchical structure in an organization, a past incident response history, an approval history of an on-site person in charge, an education history and qualification information of a worker, and a health checkup history in the processing of the automatic authority management unit, and autonomously determines and executes an optimal authority set, exception processing, automatic recording of an audit trail, immediate response in an emergency, and the like. For example, a prompt sentence such as “Worker B enters for network device setting work. Propose an optimal authority set considering a past work history of B, a current security policy, an authority requirement of a network device management system, an on-site risk level, an education history and qualification information of B, and a past incident response history” is input to generative AI, and the AI automatically generates a minimum necessary and appropriate authority set. For example, at the time of an exit event, using a prompt sentence such as “An exit event of worker C has occurred. Identify all system authorities granted to C today, preferentially deprive an authority for a system having a high deletion omission risk, and record an audit trail”, the AI realizes reliable authority deprivation considering past deletion omission cases, a dependency relationship between systems, an on-site risk level, and external threat information. For example, when work content is changed in the middle, using a prompt sentence such as “Work content of worker D has been changed from server maintenance to network setting. Delete an unnecessary authority and add a necessary authority considering new work content of D, a past work history, a security policy, an authority requirement of a network device management system, and an education history and qualification information of D”, the AI recalculates an optimal authority set, and the automatic authority management unit immediately updates an authority of each system. For example, at the time of emergency response or failure occurrence, the AI automatically determines temporary authority grant or access range expansion based on an approval of an on-site person in charge or information of an emergency notification system, and executes immediate authority deprivation after completion of work. Specifically, the generative AI execution unit includes a neural network of a transformer architecture based on a large language model. The generative AI execution unit receives input data as a text sequence of a natural language. The generative AI execution unit converts the text sequence into a high-dimensional embedding vector using a tokenizer. The generative AI execution unit generates, for example, a 512-dimensional numerical vector indicating attribute information of a worker, a past incident history, and a current system state as input data. The generative AI execution unit inputs this input vector to a plurality of encoder layers provided with a self-attention mechanism. The neural network calculates a contextual dependency relationship between respective tokens, and updates a hidden state vector. The neural network outputs a probability distribution indicating an optimal authority configuration through a decoder layer. The generative AI execution unit selects a combination of an authority set having the highest score from the output probability distribution. The generative AI execution unit outputs the selected authority set as structured data. The generative AI execution unit outputs, for example, a flag indicating read authority grant to system A, a flag indicating write authority deprivation to system B, and a floating-point number between 0 and 1 indicating an execution priority thereof as output data. The generative AI execution unit transfers this output data to a subsequent automatic authority management unit. The automatic authority management unit dynamically reconstructs an order of a processing queue based on the priority indicated by the floating-point number. The neural network is pre-trained using a large-scale dataset including past authority setting mistakes and incident cases. The neural network optimizes a weight parameter so as to minimize an error between a predicted value and a correct label using a cross-entropy error function. The system instantaneously derives an optimal solution even for an unknown situation unmanageable by a static rule base or an authority request having a complex dependency relationship by using such an advanced inference model. The system eliminates a security risk due to excessive authority grant by this processing. The system provides an extremely important technical effect of preventing information leakage and securing business continuity in a use case such as core system operation of a financial institution or access control of a research facility handling confidential information.

An audit recording unit records a history of all account management operations such as creation, deletion, authority change of each account, grant/deprivation of an access authority, API key issuance/revocation, account lock/unlock, an access log, an operation log, an alert notification, exception processing, and an emergency response history in chronological order, and automatically generates a report for audit response or internal control. For example, a dashboard capable of confirming at a glance who granted/deleted what kind of authority and when, which on-site person in charge gave what kind of approval to which worker, in which system a deletion omission or an authority grant mistake occurred, and what kind of exception processing or emergency response was executed is automatically generated. For example, when an authority setting violating a security policy is detected, a corrective plan is automatically presented, and an administrator is notified. For example, when a legal compliance requirement is changed, an authority setting based on a new requirement can be proposed, and automatically applied through an approval of an administrator. For example, an audit report or trail data is automatically generated for reporting to an external auditor or a management layer, and encryption, long-term storage, and external storage integration are also possible as necessary. Specifically, the audit recording unit asynchronously receives all transaction data generated in the system via an event-driven architecture. The audit recording unit applies a hash function to the received transaction data, and generates a digital signature for falsification prevention. The audit recording unit stores the data to which the digital signature is added in an append-only distributed ledger database. The audit recording unit executes semantic analysis using a natural language processing model on the stored huge amount of log data. The audit recording unit extracts an entity from the log data, and maps it as a node and an edge on a graph database. The audit recording unit executes a PageRank algorithm or a community extraction algorithm on the graph database. The audit recording unit automatically detects a pattern of abnormal authority transition or a potential security risk by these algorithms. The audit recording unit aggregates the detected risk information as multidimensional array data. The audit recording unit inputs the aggregated data to a visualization engine, and generates a dynamic dashboard. Upon receiving a report generation request, the audit recording unit extracts a corresponding record from the database based on a designated period and scope. The audit recording unit inputs the extracted record to a natural language generation model. The natural language generation model converts numerical data or flag information into a summary text understandable by a human. The audit recording unit automatically generates an audit report combining the summary text and a statistical graph. The system unravels a complex correlation at high speed while guaranteeing log integrity by combining distributed ledger technology and graph analysis. The system significantly reduces calculation resources and time required for audit work by this unconventional data processing method. The system brings about a technical effect of automation of compliance and strictness of trail management in a use case such as an internal control audit of a listed company or authentication maintenance of an international security standard.

A user interface unit provides a dashboard or an operation screen capable of confirming an account management status for each worker, a risk evaluation result by generative AI, an alert notification, an audit trail, an operation history, an exception processing history, an emergency response history, and the like in real time by an administrator or an on-site person in charge through a Web browser or a dedicated application. For example, an administrator can perform an account lock in an emergency or an exceptional authority grant application from a terminal. For example, a work content change or an exit event can be manually registered from a terminal, and account management processing can be immediately triggered. For example, an audit report can be downloaded and submitted to an external auditor or a management layer. An operation manual for education, a tutorial video, and an FAQ automatic generation function are also provided. For example, an on-site person in charge can confirm a health checkup history or qualification information of a worker, and display a warning when necessary education or qualification is unacquired. Specifically, the user interface unit operates as a single page application constructed using a front-end framework. The user interface unit establishes a constant connection with a back-end server using a bidirectional communication protocol. The user interface unit receives a push notification every time a state change occurs on a server side. The user interface unit analyzes a received payload, and redraws only a specific component of a screen by updating a virtual document object model. The user interface unit captures an input event from a user, and performs validation processing on input data. The user interface unit transmits data passing validation to a server as a stateless API request. The user interface unit comprises a rendering engine for visualizing a risk evaluation result by generative AI as a heat map or a radar chart. The user interface unit converts a multidimensional evaluation score into two-dimensional pixel data using the rendering engine. The user interface unit temporarily saves an operation history of a user in a local storage. The user interface unit shifts to an offline mode when a network is disconnected, and synchronizes a cached operation log to a server when reconnected. The system eliminates reloading of an entire screen by adopting an asynchronous communication architecture combining a virtual document object model and bidirectional communication. The system realizes response performance in units of milliseconds while minimizing consumption of a network bandwidth by this processing. The system exhibits a technical effect of eliminating an operation delay and dramatically improving a user experience in a use case such as a large-scale monitoring center or a system administrator terminal under a remote work environment.

An external system integration unit integrates with various internal and external business systems and external services such as a physical entry/exit management system, a surveillance camera management system, a network device management system, a server management system, a configuration management system, a power management system, a facility monitoring system, a cloud infrastructure management system, a storage management system, a backup management system, a security monitoring system, an access log management system, a VPN management system, a remote access management system, and an API management system through authentication integration such as an API, batch processing, Webhook, SAML, and OAuth, and collectively and automatically executes operations such as account creation, deletion, and authority change. For example, even when a new business system or external service is added, a structure capable of easily responding by API integration or plugin addition is adopted, and integration with a plurality of bases or group companies, multilingual support, time zone support, local law and regulation support, and the like are also automatically optimized. For example, in the event of a failure, a state of an integration destination system is monitored, and when processing fails, a retry or an alternative procedure is automatically executed, and an administrator is notified. For example, when a contract of an external contractor ends or a qualification expires, an authority is automatically deprived from all related systems, and an account is deactivated. Specifically, the external system integration unit is implemented as an independent container group based on a microservice architecture. The external system integration unit dynamically loads an adapter module specialized for each integration destination system. The external system integration unit inputs an internal standardized data model to each adapter module. The adapter module converts the standard data model into a unique data format requested by an integration destination system. The external system integration unit generates a communication request using the converted data. The external system integration unit adds an access token acquired using an authentication protocol to a request header. The external system integration unit transmits a request through an encrypted communication path. The external system integration unit analyzes a response code returned from a transmission destination system. The external system integration unit dynamically adjusts a transmission interval using a token bucket algorithm when receiving a response indicating that a rate limit has been reached. The external system integration unit implements a circuit breaker pattern, and temporarily blocks request transmission to the system when detecting continuous communication errors. The external system integration unit saves a request in a message queue during blocking, and asynchronously resumes processing after system recovery. The system autonomously executes such advanced traffic control and a failure isolation mechanism inside a computer. The system prevents a failure of a single external system from spreading to the entire system by this processing. The system brings about an extremely important technical effect of improving availability of the entire system and strengthening fault tolerance in a use case such as integrated management of a multi-cloud environment or IT infrastructure operation of a global company.

Specific examples of prompt sentences to be read into the generative AI necessary for carrying out the present invention include: “Worker B enters for network device setting work. Propose an optimal authority set considering B's past work history, a current security policy, an authority requirement of a network device management system, an on-site risk level, B's education history and qualification information, and a past incident response history,” “An exit event of worker C has occurred. Identify all system authorities granted to C today, preferentially deprive an authority for a system having a high deletion omission risk, and record an audit trail,” “The work content of worker D has been changed from server maintenance to network setting. Delete an unnecessary authority and add a necessary authority considering D's new work content, a past work history, a security policy, an authority requirement of a network device management system, and D's education history and qualification information,” and “At the time of an emergency response or a failure occurrence, automatically determine a temporary authority grant or an access range expansion based on approval of an on-site person in charge or information of an emergency notification system, and execute immediate authority deprivation after the work is completed.” Specifically, the present system does not treat these prompt sentences in natural language as mere character strings, but manages them as structured prompt templates in internal processing. The present system binds dynamic variables extracted from a database to placeholders in the templates. The present system inputs the bound text data to a tokenizer and converts it into a token identifier list which is an array of integers. The present system supplies this token identifier list to an input layer of a large language model. The present large language model applies a self-attention mechanism to the input token sequence and calculates a semantic distance between respective words on a multidimensional vector space. The present large language model dynamically assigns a high weighting coefficient based on past incident data to a phrase “high deletion omission risk”, for example. The present large language model inputs the calculated hidden state vector to a fully connected layer and a softmax function. The present large language model calculates a probability distribution of a token to be output next. The present system generates a token sequence having the highest probability using a beam search algorithm. The present system inversely converts the generated token sequence into natural language text or structured data again using a decoder. The present system extracts parameters of a system identifier of an authority grant target, an operation type, and an expiration date from the output structured data. The present system passes the extracted parameters to a subsequent API calling module. The present system completely automates a series of processing from prompt generation to model inference and result parsing. The present system breaks through the limit of conventional script processing in which a human operator manually describes conditional branching by this non-conventional processing method. The present system enables dynamic authority control based on understanding of a complex context. The present system exhibits technical effects of dramatic reduction of an operation load and complete elimination of a setting mistake in use cases such as unmanned operation of a data center requiring high security and an agile development environment in which work content is frequently changed.

### Implementation Steps

### Step 1: Registration/Update of Worker Information

The personnel information management unit centrally databases and manages all attribute information such as a name, a facial photograph, contact information, an affiliated organization, an employment form, a contract period, a scheduled entry date and time, a scheduled exit date and time, work content, a project in charge, a past work history, a past authority history, a past security incident history, an education history, qualification information, a health checkup history, emergency contact information, and on-site person in charge information of an operation administrator, a maintenance worker, an external contractor, a security person in charge, a cleaner, an equipment inspector, a temporary worker, a night worker, and the like who enter and exit the data center. For example, when an external contractor enters for server maintenance work, the name, affiliated company, scheduled work date and time, work content, past entry/exit history, past granted authority and its valid period, past security incident history, education attendance history, presence or absence of a health checkup, and the like of the worker are recorded in detail. Specifically, the present personnel information management unit stores the input various attribute information in a group of normalized tables of a relational database. The present personnel information management unit executes feature extraction processing using a convolutional neural network for unstructured data such as a facial photograph. The present personnel information management unit converts the extracted facial features into a 512-dimensional floating-point vector. The present personnel information management unit indexes and saves this feature vector in a vector database. The present personnel information management unit executes morphological analysis and named entity recognition for text data. The present personnel information management unit constructs the extracted keywords as an inverted index. When receiving a data registration and update request, the present personnel information management unit guarantees atomicity, consistency, isolation, and durability of a transaction using an exclusive control mechanism. The present personnel information management unit publishes an event message including change content to a message broker at the same time as the update processing is completed. The present system adopts a hybrid database architecture that integrally manages structured data and unstructured data. The present system reduces a data search speed in subsequent authentication processing or authority determination to logarithmic time complexity by this processing. The present system brings about technical effects of maintaining data consistency and dramatically improving search performance in use cases such as data center management of a mega cloud provider where a large number of personnel frequently enter and exit, and entry/exit management of a critical infrastructure facility where strict identity verification is required.

### Step 2: Event Detection and Identification of Work Event

The event detection unit monitors event information such as entry, exit, work content change, emergency response, failure occurrence, temporary work permission, work interruption, work extension, and work cancellation from the personnel information management unit, a work schedule management system, a physical entry/exit management system, a facial recognition gate, an IC card reader, a biometrics authentication device, an on-site reception terminal, a work instruction system, an emergency notification system, and the like in real time or at a predetermined cycle, and immediately detects the event information when an event occurs. For example, when an external contractor passes through an entry gate for server maintenance work, an entry event is detected from a facial recognition log, an IC card authentication log, or an operation history of a reception terminal. Specifically, the present event detection unit continuously receives a binary data stream including biometric authentication data and a serial number of an IC card transmitted from each sensor and terminal. The present event detection unit decodes the received binary data and converts it into a structured record including a timestamp, a device identifier, and an authentication score. The present event detection unit acquires a feature vector of a facial image transmitted from the facial recognition gate. The present event detection unit calculates a cosine similarity between the acquired feature vector and a reference vector registered in advance in the vector database. The present event detection unit determines that the person is the same person when the calculated similarity exceeds a predetermined threshold. The present event detection unit inputs related logs transmitted from a plurality of devices within a short time to a complex event processing engine. The present complex event processing engine analyzes the order and correlation of events within a temporal window. The present complex event processing engine confirms a legitimate entry event only when, for example, an IC card touch and a successful facial recognition occur consecutively within 2 seconds. The present event detection unit assigns a unique transaction identifier to the confirmed event. The present event detection unit writes this event data to an in-memory data grid and triggers a notification to a subsequent module. The present system uses a sensor fusion technology that integrally evaluates a plurality of sensor data in a high-dimensional space. The present system mathematically eliminates a false detection due to a malfunction of a single sensor or a spoofing attack by this non-conventional processing method. The present system exhibits technical effects of extremely improving authentication accuracy and completely preventing unauthorized intrusion in use cases such as a military facility or a server room of a financial institution where high physical security is required.

### Step 3: Optimization and Determination of Authority Set by Generative AI

The generative AI execution unit comprehensively analyzes all related information such as work content of a worker, a past work history, a security policy, an access requirement for each system, an on-site risk level, case data of deletion omissions and authority grant mistakes, external threat information, a legal compliance requirement, an audit trail, an authority hierarchical structure in an organization, a past incident response history, an approval history of an on-site person in charge, an education history and qualification information of a worker, and a health checkup history in the processing of the automatic authority management unit, and autonomously determines and executes an optimal authority set, exception processing, automatic recording of an audit trail, immediate response in an emergency, and the like. For example, a prompt sentence such as “Worker B enters for network device setting work. Propose an optimal authority set considering B's past work history, a current security policy, an authority requirement of a network device management system, an on-site risk level, B's education history and qualification information, and a past incident response history” is input to the generative AI, and the AI automatically generates a minimum necessary and appropriate authority set. Specifically, the present generative AI execution unit supplies the input prompt sentence and related context data to an input layer of a natural language processing model. The present generative AI execution unit formats a past access log of the worker as a time-series tensor as the context data. The present generative AI execution unit expresses the security policy as a set of nodes and edges of a knowledge graph. The present generative AI execution unit maps these heterogeneous data to a common latent space vector using a multimodal encoder. The present neural network calculates a hidden correlation between the work content and the authority requirement of each system using a self-attention mechanism of a transformer architecture. The present neural network is trained by incorporating a penalty function based on past incident data into a loss function. The present neural network calculates a risk score when each authority is granted using this trained weight parameter. The present generative AI execution unit identifies a combination of minimum authorities necessary for performing the work, the risk score of which falls below an allowable threshold, by a search algorithm. The present generative AI execution unit outputs the identified authority set as array data including a target system identifier, an operation authority level, and an expiration date. The present generative AI execution unit generates, for example, a command object that grants a setting change authority for router A for a limited time of 2 hours as output data. The present generative AI execution unit transmits the generated output data to the subsequent automatic authority management unit. The present system solves an optimization problem satisfying complex constraint conditions in a non-linear space using a deep learning model. The present system completes an authority design, which takes several tens of minutes for a human administrator, in several milliseconds by this processing. The present system brings about technical effects of dramatically improving calculation efficiency and strictly applying the principle of least privilege in use cases such as dynamic reconfiguration of a large-scale IT infrastructure and rapid switching of access control when an incident occurs.

### Step 4: Execution of Authority Grant, Deprivation, and Change by Automatic Authority Management Unit

The automatic authority management unit automatically executes processing such as account creation, deletion, authority grant/deprivation/change, access restriction, account lock, API key issuance/revocation, usage period setting, two-factor authentication setting, access range restriction, operation log acquisition setting, and alert notification setting of a corresponding person for all systems in the data center, such as a physical entry/exit management system, a surveillance camera management system, a network device management system, a server management system, a configuration management system, a power management system, a facility monitoring system, a cloud infrastructure management system, a storage management system, a backup management system, a security monitoring system, an access log management system, a VPN management system, a remote access management system, and an API management system, based on the optimal authority set determined by the generative AI execution unit. Specifically, the present automatic authority management unit parses the array data received from the generative AI execution unit and generates an individual task object for each target system. The present automatic authority management unit enqueues the generated task object to a distributed task queue. The present automatic authority management unit activates a plurality of worker processes and asynchronously dequeues the task from the queue. The present worker process serializes a payload in accordance with an API specification of the target system. The present worker process transmits an update request to an endpoint of the target system using encrypted communication. The present worker process monitors a status code from the target system. The present worker process determines that the processing is successful when the status code indicates normal, and updates an authority state flag in an internal database. When receiving an error response due to a network delay or a temporary system down, the present worker process schedules retransmission processing using an exponential backoff algorithm with jitter. The present automatic authority management unit commits a series of transactions after confirming that all tasks are completed. When a fatal error occurs during the processing, the present automatic authority management unit issues a compensating transaction to roll back the already applied authority change. The present system enables simultaneous and parallel authority changes for hundreds of heterogeneous systems by adopting distributed queuing and an asynchronous worker model. The present system eliminates a communication bottleneck between systems and maximizes throughput by this non-conventional processing method. The present system exhibits technical effects of dramatically improving a processing speed and maintaining complete consistency of a system state in use cases such as simultaneous account update accompanying company-wide personnel transferring and immediate shutoff of all systems when a cyber attack is detected.

### Step 5: Management by Audit Record and User Interface, and External System Integration

An audit record unit records a history of all account management operations such as creation, deletion, authority change, grant/deprivation of access authority, API key issuance/revocation, account lock/unlock, access log, operation log, alert notification, exception processing, and emergency response history of each account in chronological order, and automatically generates a report for audit response and internal control. A user interface unit provides a dashboard and an operation screen that allow an administrator or an on-site person in charge to check an account management status for each worker, a risk evaluation result by the generative AI, an alert notification, an audit trail, an operation history, an exception processing history, an emergency response history, and the like in real time through a Web browser or a dedicated application. An external system integration unit integrates with various internal and external business systems and external services such as a physical entry/exit management system, a surveillance camera management system, a network device management system, a server management system, a configuration management system, a power management system, a facility monitoring system, a cloud infrastructure management system, a storage management system, a backup management system, a security monitoring system, an access log management system, a VPN management system, a remote access management system, and an API management system through authentication integration such as API, batch processing, Webhook, SAML, and OAuth, and collectively and automatically executes operations such as account creation, deletion, and authority change. Specifically, the present audit record unit aggregates an execution log output from the automatic authority management unit in real time using a stream processing engine. The present audit record unit writes the aggregated log data to an immutable distributed ledger together with a hash value. The present audit record unit mathematically makes data falsification impossible by this processing. The present user interface unit issues a query to a backend endpoint. The present user interface unit stores the acquired data having a complex hierarchical structure in a state management container on a memory on a client side. The present user interface unit detects a state change and reactively updates an element on a screen. The present user interface unit transmits a state change request by an operation of the administrator to a server as a mutation. The present external system integration unit uses a service mesh architecture in communication with an external service. The present external system integration unit automatically executes traffic routing, encryption, and observability metrics collection through a sidecar proxy. The present external system integration unit dynamically generates an authentication token and establishes a secure authentication and authorization flow across domains. The present system loosely couples these independent module groups by an event-driven architecture. The present system enables independent scaling of each component by this configuration. The present system brings about technical effects of improving expandability of the entire system and dramatically reducing an operation and maintenance cost in use cases such as an integrated IT infrastructure of a multinational corporation expanding globally and operation management of a hybrid cloud environment across a plurality of cloud providers.

### Specific Use Case

For example, when a maintenance worker of an external contractor enters for server maintenance work in a data center, the personnel information management unit databases and manages a name, a facial photograph, an affiliated company, a contract period, a health checkup history, an education history, qualification information, a past work history, a past authority history, emergency contact information, on-site person in charge information, and the like of the worker in detail. The event detection unit detects an entry event from a work schedule management system, a physical entry/exit management system, a facial recognition gate, an IC card reader, or the like in real time, and when the entry of the worker is confirmed, the automatic authority management unit automatically grants a minimum necessary and appropriate authority according to work content, such as a physical entry/exit authority to a server room, an unlocking authority for a corresponding rack, an access authority to a server management console, a viewing authority for a surveillance camera video, a setting change authority for a network device, an operation authority for a power management system, and a viewing authority for a facility monitoring system. The generative AI execution unit comprehensively analyzes a past work history of the worker, a current security policy, an access requirement for each system, an on-site risk level, an education history and qualification information, a past incident response history, and the like, inputs a prompt sentence such as “Worker A enters for server maintenance work. Propose an optimal authority set considering A's past work history, a security policy, an authority requirement of a server management system, an on-site risk level, and A's education history and qualification information” to the generative AI, for example, and the AI automatically generates a necessary authority set. When the work content is changed to network device setting work in the middle, the event detection unit detects a work change event, the generative AI execution unit recalculates an optimal authority set using a prompt sentence such as “The work content of worker A has been changed from server maintenance to network setting. Delete an unnecessary authority and add a necessary authority considering A's new work content, a past work history, a security policy, an authority requirement of a network device management system, and A's education history and qualification information,” and the automatic authority management unit immediately deprives the unnecessary authority of the server management system and additionally grants the necessary authority of the network device management system. When the worker passes through an exit gate after the work is completed, the event detection unit detects an exit event, the generative AI execution unit realizes reliable authority deprivation considering past deletion omission cases, a dependency relationship between systems, an on-site risk level, and external threat information using a prompt sentence such as “An exit event of worker A has occurred. Identify all system authorities granted to A today, preferentially deprive an authority for a system having a high deletion omission risk, and record an audit trail,” and the audit record unit records all authority grant, deprivation, and change histories in chronological order and automatically generates a report for audit response and internal control. Furthermore, at the time of an emergency response or a failure occurrence, the generative AI execution unit automatically determines a temporary authority grant or an access range expansion based on approval of an on-site person in charge or information of an emergency notification system, and executes immediate authority deprivation after the work is completed. For example, a prompt sentence such as “Worker B enters urgently for failure response. Temporarily grant a necessary authority considering B's past incident response history, an on-site risk level, and approval information of an on-site person in charge, and immediately deprive the authority after the work is completed” can be used. In this way, the system of the present invention works in conjunction with all entry/exit and work events in the data center, automatically optimizes and manages access authorities on both physical and logical sides based on the analysis of the generative AI, and can simultaneously realize reduction of a security risk, operation efficiency improvement, prevention of a human error, automatic recording of an audit trail, immediate response in an emergency, and the like. Specifically, the present system processes a series of these business flows not as mere sequential script execution but as dynamic orchestration based on a state transition machine inside a computer. The present system maps a lifecycle from entry to exit of a worker on a memory as a state node of a finite automaton. The present system asynchronously routes event data that triggers each state transition via a message queue. The present system inputs the input prompt sentence to an encoder layer of a natural language processing model and converts it into a high-dimensional context vector in the generative AI execution unit. The present system inputs this context vector to a decoder layer and outputs an execution plan including a specific API calling sequence for a target system group. The present system generates structured data including an endpoint, a communication method, and a payload for calling an authority grant API of the server management system as output data, for example. The present system passes this execution plan to a parallel execution engine of the automatic authority management unit. The present parallel execution engine simultaneously executes API calls having no dependency relationship in a plurality of threads. The present system safely pauses a currently executing transaction when detecting an interrupt event such as a change in work content or an occurrence of an emergency. The present system inputs a new context vector to the generative AI execution unit to dynamically recalculate the execution plan. The present system executes deprivation of an unnecessary authority and grant of a new authority as an atomic operation based on the recalculated difference plan. The present system appends all operation logs to an audit database having a hash chain structure in real time. The present system adopts a non-conventional architecture that tightly couples such advanced state management and inference by a deep learning model. The present system causes access control in a logical space to follow a dynamic change in a physical space with a delay in milliseconds by this processing. The present system always keeps a security state of a system group having a complex dependency relationship optimal without intervention of human judgment. The present system exhibits an ultimate technical effect of mathematically bringing an occurrence probability of a security incident close to zero and extremely reducing an operation cost in use cases such as completely unmanned operation of a mission-critical data center and an autonomous system recovery process at the time of a disaster.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

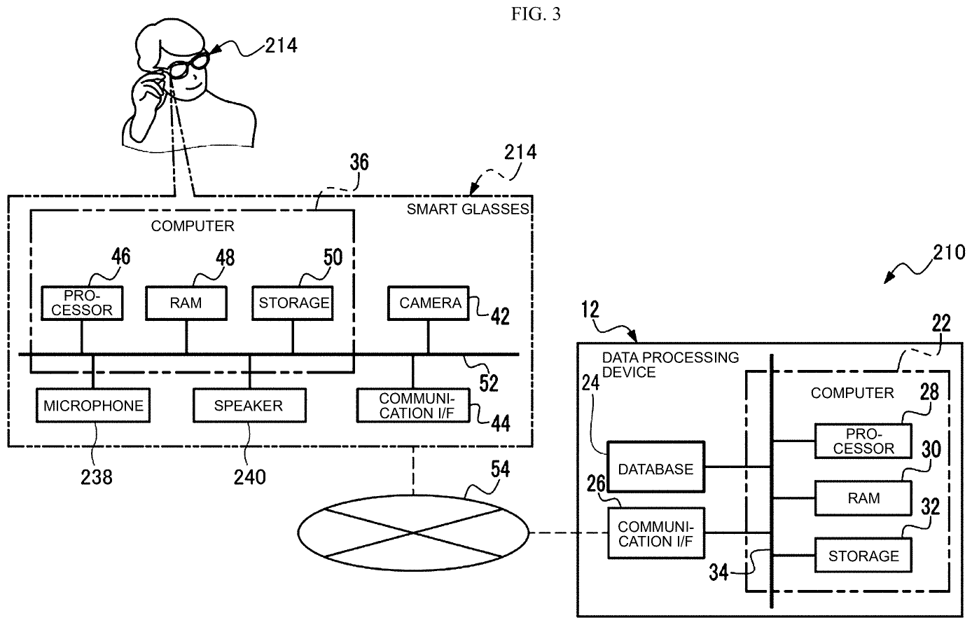

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

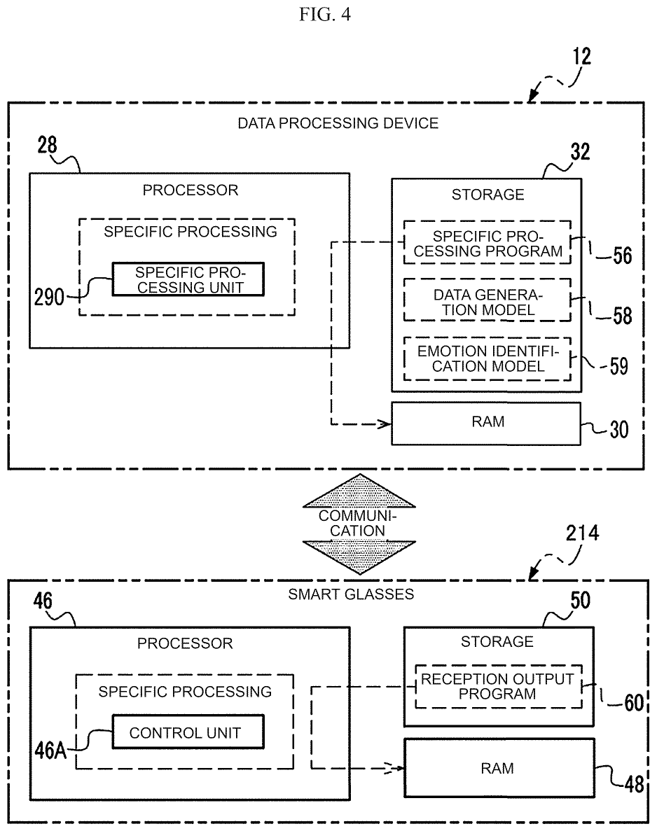

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

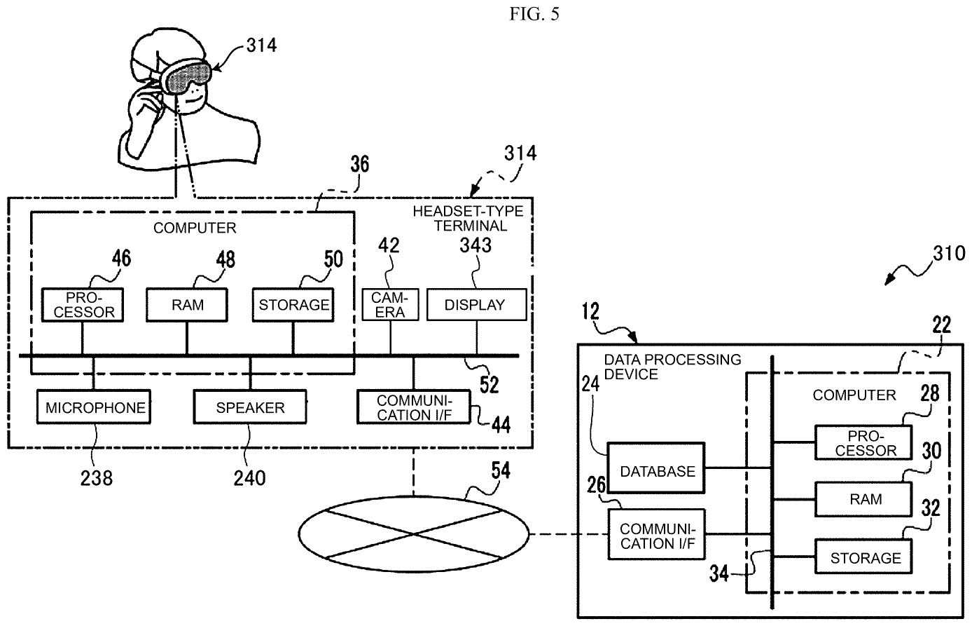

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

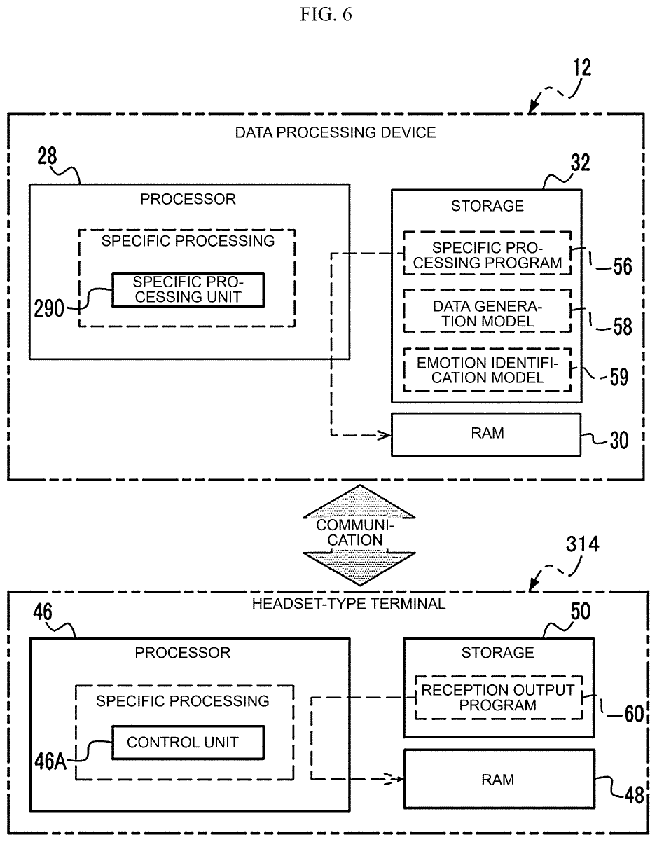

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

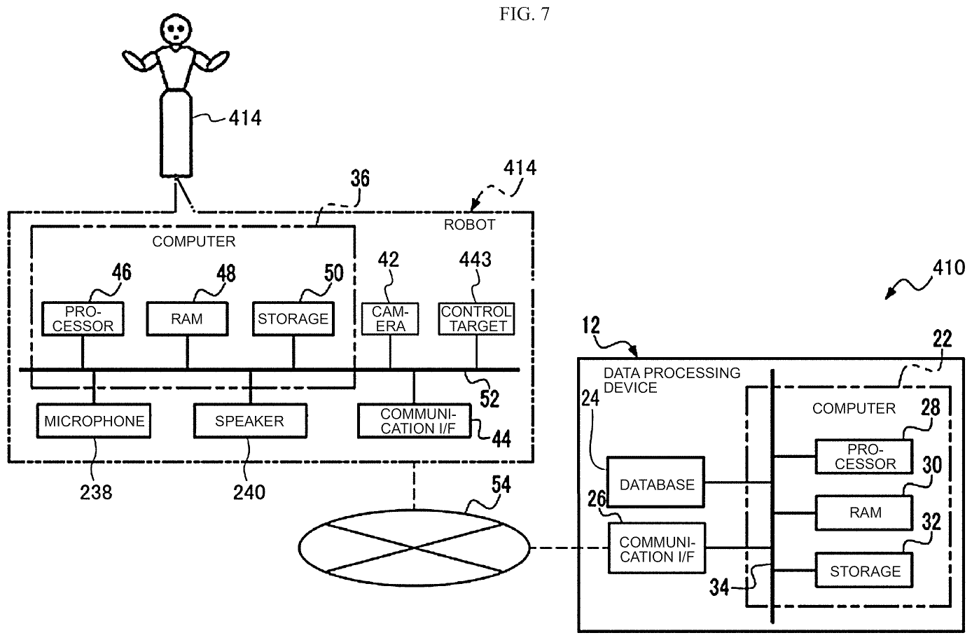

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

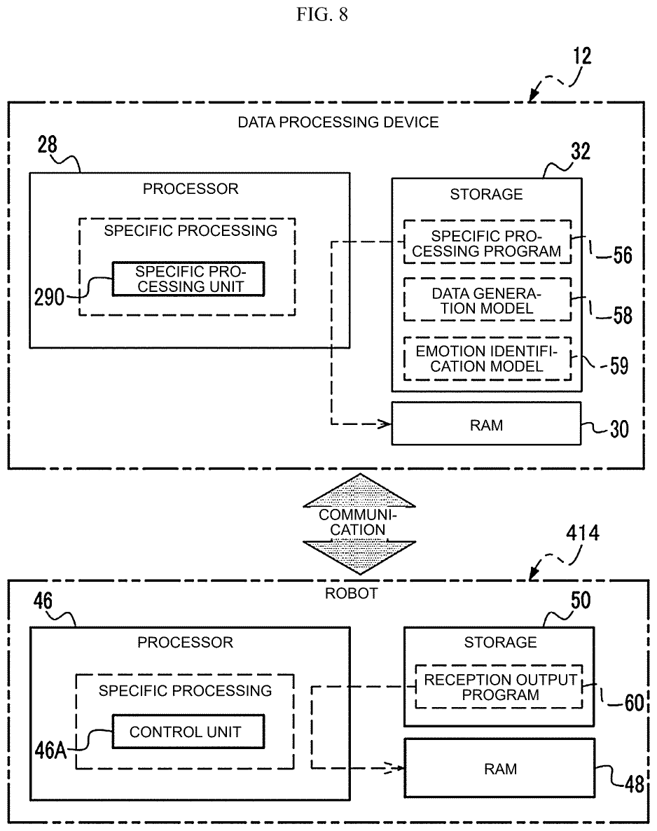

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

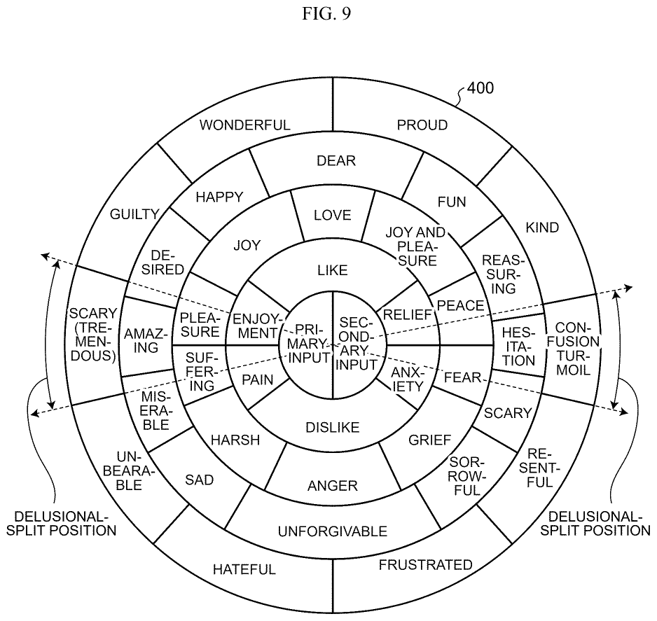

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

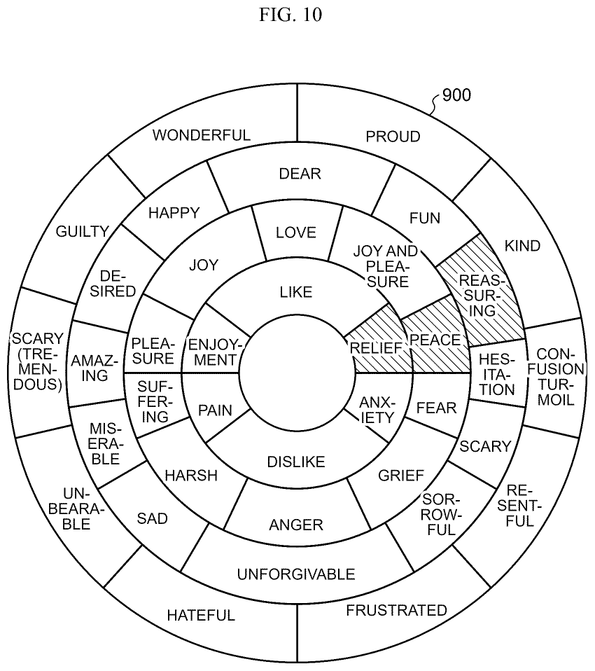

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A data center authority management system comprising: a personnel information management unit; an event detection unit; an automatic authority management unit; and a generative AI execution unit, wherein the personnel information management unit is configured to centrally manage attribute information, scheduled entry/exit, work content, an affiliation, a past work history, an authority history, a security policy compliance status, and the like of an operation administrator, a maintenance worker, an external contractor, a security person in charge, and the like who enter and exit a data center; the event detection unit is configured to monitor event information such as entry, exit, and work content change from the personnel information management unit and a work schedule management system in real time or at a predetermined cycle to detect the event information; the automatic authority management unit is configured to automatically execute account creation, deletion, authority grant/deprivation/change, access restriction, account lock, API key issuance/revocation, usage period setting, and the like of a corresponding person for a plurality of in-data-center systems such as a physical entry/exit management system, a surveillance camera management system, a network device management system, and a configuration management system based on the event detected by the event detection unit; and the generative AI execution unit is configured to use generative AI to analyze work content of a worker, a past work history, a security policy, an access requirement for each system, an on-site risk level, case data of deletion omissions and authority grant mistakes, external threat information, and the like in the processing of the automatic authority management unit, and to autonomously determine and execute an optimal authority set, exception processing, automatic recording of an audit trail, immediate response in an emergency, and the like.

### Supplementary Note 2

The system according to Supplementary Note 1, wherein the generative AI execution unit is configured to comprehensively analyze work content of a worker, a past work history, a security policy, an on-site risk level, an access requirement for each system, case data of deletion omissions and authority grant mistakes, and the like when an entry event occurs, and automatically generate a minimum necessary and appropriate authority set in real time; and the automatic authority management unit is configured to collectively and automatically execute account creation and authority grant for the plurality of in-data-center systems based on this.

### Supplementary Note 3

The system according to Supplementary Note 1, wherein the generative AI execution unit is configured to identify all authorities granted during a corresponding work period of a worker when an exit event or a work content change event occurs, analyze past deletion omissions, an authority remaining risk, a dependency relationship between systems, an audit trail, external threat information, and the like, preferentially deprive an authority for a system having a high deletion omission risk, immediately delete an unnecessary authority, grant a new authority if necessary, and automatically save all processing results as an audit record.

What is claimed is:

1. A system comprising:
circuitry configured to:
receive, via a communication interface coupled to a packet-switched network, subject attribute data comprising image data, organizational relationship data, and lifecycle state parameters for a plurality of subjects, and store the subject attribute data in a hybrid data store comprising a relational database and a document-oriented database in a storage device;
apply a convolutional neural network to the image data to extract facial feature vectors of a predetermined number of dimensions, and index the facial feature vectors in a vector database for high-speed similarity-based retrieval;
construct an organizational relationship graph in memory comprising subject attribute nodes and directed edges representing project membership and organizational unit relationships, and store the organizational relationship graph in the storage device;
monitor lifecycle event data from the hybrid data store to detect state transition events associated with subject attribute records, and apply a generative neural network model to the organizational relationship graph and subject attribute data to determine access permission parameter modifications corresponding to each detected state transition event; and
execute the access permission parameter modifications across a plurality of downstream system endpoints via an API integration layer and record each modification as an audit event record in the storage device.

2. The system according to claim 1, wherein the circuitry is configured to receive a query image from a terminal device via the communication interface, apply the convolutional neural network to the query image to generate a query facial feature vector, compute cosine similarity scores between the query facial feature vector and indexed facial feature vectors in the vector database, and return a matching subject identifier when a cosine similarity score exceeds a similarity threshold parameter.

3. The system according to claim 2, wherein the circuitry is configured to compare a matched subject identifier against a current access permission parameter record, retrieve a permitted area identifier and a permitted time window parameter associated with the subject identifier, and issue an access grant or access denial command to a physical access control device via the communication interface based on whether the current time is within the permitted time window parameter.

4. The system according to claim 3, wherein the circuitry is configured to generate a time-limited access profile for subject attribute records flagged with a temporary access state parameter, the time-limited access profile comprising a valid period timestamp, a permitted resource identifier set restricted to specified access zones, and an auto-expiration command to be transmitted to the physical access control device at the end of the valid period.

5. The system according to claim 1, wherein the circuitry is configured to traverse the organizational relationship graph by executing a breadth-first search from a subject attribute node associated with a state transition event, identify all subject attribute nodes sharing project membership or organizational unit edges with the originating node, and generate a scope vector enumerating affected downstream system endpoints requiring access permission parameter review.

6. The system according to claim 5, wherein the circuitry is configured to apply the generative neural network model to the scope vector and historical access permission parameter records associated with the affected subject attribute nodes to generate an optimal access permission modification plan, and transmit access permission modification commands to each downstream system endpoint identified in the scope vector via the API integration layer.

7. The system according to claim 1, wherein the circuitry is configured to apply the generative neural network model to historical audit event records associated with past access permission modification operations to extract risk pattern features, compute a risk score for each proposed access permission modification, and generate an exception processing workflow when the risk score exceeds a risk threshold parameter.

8. The system according to claim 7, wherein the circuitry is configured to transmit an alert notification to a terminal device specifying the exception processing workflow when an exception is generated, receive an approval response from the terminal device via the communication interface, and execute the access permission modification only after receiving an approval response associated with an authorized administrator user identifier.

9. The system according to claim 1, wherein the circuitry is configured to store fixed-form subject attribute data comprising identifier fields and classification parameters in a relational table of the relational database, and store non-fixed-form subject attribute data comprising image data and historical record data as document-format objects in the document-oriented database, the storage device mapping subject identifiers across both database types for unified retrieval.

10. The system according to claim 9, wherein the circuitry is configured to apply the generative neural network model to non-fixed-form historical record data extracted from the document-oriented database to generate a behavioral feature vector for each subject, and incorporate the behavioral feature vector as an additional attribute node property in the organizational relationship graph.

11. The system according to claim 1, wherein the circuitry is configured to receive an access permission modification request from a terminal device via the communication interface, apply the generative neural network model to the subject attribute data and a security policy data record to determine whether the requested modification is consistent with the minimum access policy, and generate an approval or rejection recommendation with an explanation text for transmission to the terminal device.

12. The system according to claim 1, wherein the circuitry is configured to execute access permission parameter modifications across a plurality of downstream system endpoints in a batch processing operation by generating a batch command set from the determined access permission modifications, transmit the batch command set to downstream system endpoints via the API integration layer, and monitor response status codes from each downstream system endpoint for confirmation.

13. The system according to claim 12, wherein the circuitry is configured to store response status codes and execution timestamps in the audit event record for each downstream system endpoint modification, generate a reconciliation report identifying downstream system endpoints that returned error status codes, and retransmit access permission modification commands to error-reporting endpoints using an exponential backoff retry algorithm.

14. The system according to claim 1, wherein the circuitry is configured to update the generative neural network model by generating training pairs from historical state transition events and corresponding validated access permission modification records, and fine-tune the generative neural network model on the training pairs to improve accuracy for specific organizational attribute patterns.

15. The system according to claim 1, wherein the circuitry is configured to record all access permission parameter modifications, state transition events, and system access histories in the audit event record data structure with timestamps and subject identifiers, maintain the audit event record data structure as a tamper-resistant append-only log, and transmit audit event records to a terminal device in response to a query request.

16. The system according to claim 1, wherein the circuitry is configured to encrypt all data transmissions to downstream system endpoints using a transport layer security protocol, and enforce a token-based authorization check for all incoming requests to modify subject attribute data or access permission parameters.

17. The system according to claim 1, wherein the subject attribute data comprises temporal access parameters specifying permitted access intervals and permitted resource identifiers for subjects with time-restricted access profiles, and the organizational relationship graph edges represent project membership constraints that determine scope of access permission parameter changes upon state transition events.

18. A system comprising:
circuitry configured to:
receive, via a communication interface coupled to a packet-switched network, subject attribute data comprising image data, organizational relationship data, and lifecycle state parameters, and store the subject attribute data in a hybrid data store;
apply a convolutional neural network to the image data to extract facial feature vectors and index the facial feature vectors in a vector database, and construct an organizational relationship graph comprising subject attribute nodes and directed relationship edges;
receive a query image from a terminal device, compute cosine similarity scores between a query facial feature vector and indexed facial feature vectors in the vector database, and issue an access grant or denial command to a physical access control device based on a matched subject identifier and corresponding access permission parameters;
monitor lifecycle event data to detect state transition events, and apply a generative neural network model to the organizational relationship graph to determine access permission parameter modifications corresponding to detected state transition events; and
execute the access permission parameter modifications across downstream system endpoints via an API integration layer and record each modification in an audit event record.

19. The system according to claim 18, wherein the circuitry is configured to apply the generative neural network model to historical audit event records to compute a risk score for each proposed access permission modification, generate an exception processing workflow when the risk score exceeds a risk threshold parameter, and transmit the exception processing workflow to a terminal device for administrator approval before executing the corresponding access permission modification.

20. A method comprising:
receiving, via a communication interface coupled to a packet-switched network, subject attribute data comprising image data, organizational relationship data, and lifecycle state parameters for a plurality of subjects, and storing the subject attribute data in a hybrid data store comprising a relational database and a document-oriented database in a storage device;
applying a convolutional neural network to the image data to extract facial feature vectors of a predetermined number of dimensions, and indexing the facial feature vectors in a vector database for high-speed similarity-based retrieval;
constructing an organizational relationship graph in memory comprising subject attribute nodes and directed edges representing project membership and organizational unit relationships;
monitoring lifecycle event data from the hybrid data store to detect state transition events associated with subject attribute records, and applying a generative neural network model to the organizational relationship graph and subject attribute data to determine access permission parameter modifications corresponding to each detected state transition event; and
executing the access permission parameter modifications across a plurality of downstream system endpoints via an API integration layer and recording each modification as an audit event record in the storage device.
